(19) United States
(12) Patent Application Publication
(10) Pub. No.: US 2013/0314632 A1
(43) Pub. Date: Nov. 28, 2013

(54) FAST TUNABLE LIQUID CRYSTAL OPTICAL APPARATUS AND METHOD OF OPERATION

(71) Applicants: Armen Zohrabyan, Quebec (CA); Karen Asatryan, Quebec (CA); Tigran Galstian, Quebec (CA); Vladimir Presniakov, Quebec (CA); Amir Tork, Quebec (CA); Aram Bagramyan, Quebec (CA)

(72) Inventors: Armen Zohrabyan, Quebec (CA); Karen Asatryan, Quebec (CA); Tigran Galstian, Quebec (CA); Vladimir Presniakov, Quebec (CA); Amir Tork, Quebec (CA); Aram Bagramyan, Quebec (CA)

(73) Assignee: LENSVECTOR INC., Sunnyvale, CA (US)

(21) Appl. No.: 13/991,935

(22) PCT Filed: Dec. 9, 2011
(86) PCT No.: PCT/CA2011/050765

§ 371 Date: Aug. 6, 2013

Related U.S. Application Data
(60) Provisional application No. 61/422,115, filed on Dec. 10, 2010.

(51) Int. Cl. G02F 1/13; G02B 7/28

(52) U.S. Cl. CPC G02F 1/1313; G02B 7/28
USPC 349/36

(57) ABSTRACT

A tunable liquid crystal lens employing a dual frequency liquid crystal material exhibiting a dielectric anisotropy about a crossover frequency at room temperature is provided. A tunable liquid crystal lens drive signal having low and high frequency components about the crossover frequency, applies a spatially modulated electric field to the dual frequency liquid crystal layer, wherein the differential root means square amplitude determines the optical power. Changing the differential root means square amplitude provides optical power changes under prevailing excitation conditions providing improvements in optical power change speed. Employing drive signal pulses can impart further optical power change speed improvements. A variety of tunable liquid crystal lens structures employing the proposed solution are described.

### TECHNICAL FIELD

The present invention relates generally to electrically tunable optical devices and, more particularly, to liquid crystal optical elements having an adjustable optical characteristic.

### BACKGROUND

Tunable Liquid Crystal (TLC) optical devices are described, for example, in commonly assigned International Patent Application WO/2007/098602, which claims priority from U.S. 60/778,380 filed on Mar. 3, 2006, both of which are incorporated herein by reference. TLC optical devices are flat multi-layered structures having a Liquid Crystal (LC) layer. The liquid crystal layer has a variable refractive index which changes in response to an electric field applied thereto. Applying a non-uniform (spatially modulated) electric field to such a liquid crystal layer provides a liquid crystal layer with a non-uniform (spatially modulated) index of refraction. Moreover, liquid crystal refractive index variability is responsive to a time variable electric field. In general, TLC's are said to have an index of refraction which varies as a function of an applied drive signal producing the electric field.

The nature of the variability of the index of refraction in response to an applied electric field depends on the physical properties of TLC multi-layered structure, including properties of the liquid crystal layer material, material properties of other layers, geometry, etc. A quasi-linear “functional” relationship between the drive signal applied and the index of refraction of a TLC optical device exists over a usable drive signal variability range. However, the overall relationship is non-linear: In some TLC devices, a physical non-linear effect, known as disclination, is observed as the liquid crystal molecules begin to align with the electric field from a ground state orientation to an orientation dictated by the electric field. In broad terms, when the applied electric field is essentially homogenous, non-linearity means that the change in optical property (e.g. index of refraction) per unit drive signal change varies over the range of optical property change of the optical device.

With an appropriate geometry, a variety of optical components employing TLC optical devices may be built, for example: a tunable lens, a beam steering device, an optical shutter, etc. Tunable Liquid Crystal Lenses (TLCLs) provide significant advantages in miniature cameras, particularly in cameras with auto-focus functions including: being thin and compact. Factors such as thickness and size are important in certain applications, such as handheld equipment including, but not limited to: mobile telephone cameras, inspection equipment, etc. The performance of TLC lenses may be measured by a multitude of parameters, including: a tunable focus range, optical power (diopter) range, an optical power change speed, power consumption, etc. For image focusing purposes, an optical power of a TLC lens refers to the amount of ray bending that the TLC lens imparts to incident light (and more specifically to an incident light field referred to as a scene) passing therethrough.

The miniaturization of mobile telephones had until very recently outpaced the rate of miniaturization of optical equipment in general. Market pressures have dictated the incorporation of a digital camera into a mobile telephone. For example, a pinhole camera, using an actual hole as a focusing optical element, is focused at infinity. It would be possible, from a cost and manufacturing perspective, to incorporate into mobile telephones digital camera sensors having higher mega-pixel resolutions if focusing could be achieved by some means without sacrificing the overall mobile telephone miniaturization already achieved. One problem is that using conventional focusing techniques does not benefit from a usable increase in digital camera resolution at fixed focus. A usable increase in resolution requires active focusing means. Conventional active focusing means, employing mechanically actuated optical elements, require an undesirable increase in mobile telephone equipment casing size with increasing resolution. The use of thin and compact TLC Lenses (TLCL) has been proposed to permit a useful resolution increase for mobile telephone digital cameras. Different approaches have been proposed for providing tunable liquid crystal lenses:

A prior art experimental attempt at providing a TLC lens is Naumov et al., “Liquid-Crystal Adaptive Lenses With Modal Control” Optics Letters, Vol. 23, No. 13, p. 992, Jul. 1, 1998, which describes a one hole-patterned layered structure defined by a non-conductive center area of an electrode covered by a transparent high resistivity layer. With reference to FIG. 1, TLC 100 includes: top 102 and bottom 104 substrates, and a middle Liquid Crystal (LC) layer 110 sandwiched between top 112 and bottom 114 liquid crystal orienting layers. LC orienting layers 112/114 include polyimide coatings rubbed in a predetermined direction to align LC molecules in a ground state, namely in the absence of any controlling electric field. The predetermined orientation angle of LC molecules in the ground state is referred to herein as the pre-tilt angle. The average orientation of long liquid crystal molecular axes in a liquid crystal layer is referred to as a director. An electric field is applied to the LC layer 110 using a uniform bottom transparent conductive electrode layer 124 of Indium Tin Oxide (ITO), and the top hole-patterned conductive ring electrode layer 122 of Aluminum (Al). The low resistivity hole-patterned conductive layer 122 together with the high resistivity layer 126 immediately below the hole-patterned conductive layer 122 form an electric field shaping control layer 128. In accordance with Naumov's approach, the reactive impedance of the LC layer 110 which has capacitance and the complex impedance of the high resistivity layer 126 play a strong role, requiring driving the TLCL via specific voltage and frequency parameter pairs to minimize rms deviation from a parabolic phase retardation profile for corresponding desired optical power settings (transfer function).

Unfortunately, from a manufacturing perspective it is very difficult to produce with useful consistency the required sheet resistance of high resistivity material with high optical transparency for the highly resistive layer 126, and therefore in practice it is very difficult to produce such TLCLs consistently. Different TLCL's of the same manufacturing batch have slightly different resistances. Such sheet resistance variability coupled with the fact that control is very dependent on the precise LC cell thickness, leads to each individual TLC lens requiring separate calibration and drive. Also, the minimum diameter of a such a TLC lens is limited to about 2 mm—below this size the required resistivity of the ITO layer exceeds some 10 MΩ/sq.

Another prior art experimental attempt at providing a TLC lens is Sato et al., “Realization of Liquid Crystal Lens of Large Aperture and Low Driving Voltages Using Thin Layer of Weakly Conductive Material”, Optics Express, Vol. 16, No. 6, p. 4302, 17 Mar. 2008. With reference to FIG. 2, Sato describes a layered structure 200 having three flat electrodes in two groups. Two patterned electrodes form one group, and a single uniform electrode forms the other group. Compared to Naumov, Sato describes an additional transparent disc-shaped electrode used to provide relatively uniform electrical fields across the LC layer 110 when needed and a weakly conductive layer (WCL). Electric field shaping control layer 228 differs from that of Naumov in that the top substrate 202 and the top electrode 222/230 (group) are present in reverse order. The top electrode group includes distinct electrodes 222 and 230 in an inter-hole pattern formed in the same plane. Electrode 222 is a hole-patterned ring electrode of conductive Al, while the center electrode 230 in the top group is a fixed disk-shaped transparent conductive layer of ITO. Two drive signals U_ring and U_disk are employed. The role of the hole-patterned electrode 222 with voltage U_ring applied thereto is to create a lensing electric field profile, while the role of the central disk-shaped electrode 230 with voltage U_disk applied thereto is to reduce disclinations and to control the electric field gradient (e.g., to erase the lens). The WCL 226 in this configuration allows close positioning of the top (patterned) electrode to the bottom ITO electrode 124, thus reducing required voltages.

Unfortunately, the complex patterning of the top electrode, the necessity of using two distinct drive signal voltages and a separate WCL 226 are difficult to manufacture as a unit and inhibit practical use of this approach. For example, the use of this approach to build a polarization independent lens would require the use of six to seven thick glass lens elements.

Both of the above mentioned approaches suffer from additional drawbacks. In using Naumov's approach, the performance of such a TLC lens is very sensitive to the thickness of the LC cell as well very sensitive to the sheet resistance R_s of the highly resistive layer 126. It happens that, for millimeter size lenses, the value of R_s, for almost all known solid state materials, is in the middle of an electrical conductivity transition (percolation) zone, where the sheet resistance has a very drastic natural variation with layer 126 geometry. Thus, it is extremely difficult to achieve consistency (repeatability) in building highly resistive layers 126 with the same R_s.

As mentioned, prior art tunable LC lenses employ a driving signal having an adjustable voltage to change the optical properties of the LC layer. As mentioned above, another problem with prior art systems having patterned electrodes is the effect of “disclination.” In a typical LC lens, the LC molecules are all provided with a common pre-tilt angle for alignment at a zero voltage. When using a spatially non-uniform voltage for tuning a TLC lens having a patterned electrode, the initial voltage increase creates non-uniform electric field lines that cause some of the LC molecules to realign differently than others experiencing the same electric field strength. Such disclinations cause optical aberrations in the lens which persist with gradual voltage adjustments necessarily employed in tuning. Such disinclinations can be removed (in Sato's approach) by aligning all molecules with a very high voltage pulse that erases the lens, before reducing the voltage back to the appropriate range for providing a desired optical power.

Auto-Focus (AF) is a process implemented in many camera systems to enable easier focus acquisition for camera users, sparing them of the need to manually focus a scene. Handheld digital camera operation in auto-focus mode is negatively affected by both increased power consumption and slow response speed, factors which further negatively influence each other. An important performance characteristic of auto-focus operation is the maximum time taken by the focus acquisition process to complete. Auto-focus applications, such as handheld camera systems require good auto-focus speed performance.

Auto-focus systems are used with TLC lenses where the optical power of the TLC lens is changed by applying a drive signal to the TLC lens as indicated by an auto-focus algorithm. In contrast with conventional focusing systems, TLC lenses remain stationary at all times. There are a number of algorithmic techniques which can be employed to compute convergence to an optical power setting corresponding with best focus for a given scene. Auto-focus algorithms implement a so called full search approach, hill climb approach, etc. Auto-focus speed is in part dependent on the optical power change speed.

One of the most important drawbacks of TLCLs is their low speed in changing optical power. TLC lenses often times exhibit significant response time asymmetry in terms of how quickly continuous progress may be made in one direction through the optical parameter range as opposed to in the opposite direction. In typical TLCLs, the reorientation of liquid crystal molecules may be fast when driven by varying the control signal in a direction of increasing excitation (the long LC molecular axes are attracted by the electric field), however the relaxation of molecules in the inverse direction (back to the original alignment imposed by cell substrate treatment provided by orienting layers) is extremely slow. When employed in a variety of applications including miniature cameras, a TLC lens needs to be relatively thick in order to provide a sufficiently wide range of focus variability. However, by increasing the thickness of the LC layer, the time needed for director reorientation also increases significantly. When the TLC lens is driven via an applied electrical drive signal in the excitation direction, the time required to change optical power is also dependent on the amplitude of the drive signal, the optical power change speed can be increased by applying an electric field of a large amplitude. Optical power change speed of this transition is acceptable. In the absence of a driving signal, LC molecular relaxation time is defined by geometric (thickness), energetic (surface anchoring) and visco-elastic (rotational viscosity over elasticity constant) parameters. For simple TLC lenses having geometries useful in general consumer applications, the relaxation time is in the order of 10 s which is unacceptably slow.

In “Liquid Crystal Lens with Focal Length Variable from Negative to Positive Values” IEEE Photonics Technology Letters, Vol. 18, No. 1, p. 79, 1 Jan. 2006, Bin Wang, Moe Ye and Susumu Sato describe driving a TLC lens to vary the optical power in both positive and negative directions. FIG. 3A illustrates Sato's modified TLCL structure. A LC layer (112) of Merck E44 is sandwiched between glass substrates 1 and 2. The inner walls of the substrates are coated with polyimide films (112/114) rubbed in one direction, and the LC molecules initially align homogeneously with a small pretilt angle. A transparent ITO film and an Aluminum film are sputtered and coated, respectively, on substrates 1 and 2 as electrodes. The ITO electrode (124) is on the inner side, while the hole patterned Al electrode (222) is on the outer side of the LC cell. Above the hole patterned electrode (222) there is another ITO electrode (230) sputtered on substrate 3. The upper ITO electrode (230) is separated from the Al electrode (222) with a thin cover glass. The electric field in the LC layer is adjusted by drive signals V_1 across the Al electrode and the lower ITO electrode, and V_2 across the two ITO electrodes. Drive signals V_1 and V_2 are in phase and of the same single frequency of 1 kHz, and are used to reorient the LC directors. Generally, a larger electric field results in a larger LC director tilt angle. The applied electric field is spatially non-uniform and axially symmetrical due to the circular hole in the Al electrode (222). If V_1=V_2=0, that is, when no voltages are applied, the LC directors align homogeneously in the cell with a small pretilt angle, as shown in FIG. 3B(a). An incident light wave linearly polarized in the rubbing direction of the polyimide layers experiences a uniform phase shift and its propagation behaviors are not changed by the LC cell. If voltages are applied and V_1>V_2, the electric field in the hole area decreases gradually from the edge to the center of the hole area, and so does the reorientation of the LC directors, as shown in FIG. 3B(b). The refractive index seen by the incident light wave linearly polarized in the rubbing direction increases from the edge to the center and the wavefront of the incident light beam is focused, the TLCL operating as a positive lens. If V_1<V_2, the electric field increases from the edge to the center, and so does the reorientation of the LC directors, as shown in FIG. 3B(c). The incident light wave experiences a phase retardation that is the smallest at the center. The TLCL behaves as a negative lens, and the incident light beam is defocused. With reference to FIG. 3C, via differential adjustment of V_1 and V_2 at a single low frequency, the optical power of the TLC lens can be adjusted in both directions and the LC cell can have a variable focal length from negative to positive values. However, it is pointed out that the driving method according to this prior art attempt requires maintaining one drive signal at a certain setting while the other drive signal is varied to tune the focal length of the TLC lens, and therefore the slow optical power change identified as being problematic in simple TLCL lenses applies severally to each positive and negative optical power tuning. Just as before, increases in optical power in absolute terms can be achieved faster than decreases in optical power in absolute terms.

An advance in liquid crystal materials is described by Y. Yin, S. V. Shiyanovskii, and O. D. Layerentovich in “Thermodielectric Bistability in Dual Frequency Nematic Liquid Crystal”, Physical Review Letters 98, 097801 (2 Mar. 2007), which relates to a type of liquid crystal material MLC2048 from EM Industries referred to as Dual-Frequency (DF-LC). With reference to FIG. 4, this dual frequency liquid crystal material exhibits dielectric anisotropy which is positive for drive signals having low frequencies (e.g., 1 kHz at room temperature) and negative for high driving frequencies (e.g., above a crossover frequency f_c=17 kHz at room temperature 24° C.). This LC material has physical properties wherein the long axes of molecules are attracted by an electric field at low frequencies, and are repulsed by the electric field at high frequencies. FIG. 4A illustrates measured real (∈^{r}) and imaginary (∈ⁱ) parts of the dielectric permittivity tensor of MLC2048 in the frequency range 1 to 500 kHz at 24° C., wherein error bars are smaller than the size of the data points. This dielectric anisotropy makes it possible to accelerate LC molecular reorientation in what would otherwise have been the relaxation direction. The crossover frequency f_c is a strong monotonically increasing function of temperature, as shown in FIG. 4B.

This dielectric anisotropy phenomenon was employed by Oleg Pishnyak, Susumu Sato, and Oleg D. Lavrentovich in “Electrically tunable lens based on a dual-frequency nematic liquid crystal”, Applied Optics, Vol. 45, No. 19, p. 4576, 1 Jul. 2006 to demonstrate a fast TLCL. A TLC lens of very small dimensions having an aperture of 300 um employed an LC cell 110 um thick directly between a pair of electrodes. The LC cell was filled with the dual-frequency nematic liquid crystal material MLC-2048 (provided by Merck). This DF-LC material has a positive dielectric anisotropy Δ∈ for frequencies f of the applied electric field smaller than the crossover frequency f_c=12 kHz (at 20° C.) and negative dielectric anisotropy Δ∈ when the frequency of the drive signal f>f_c. The driving frequencies used were f=1 kHz, at which Δ∈=3.2, and f=50 kHz, at which Δ∈=3.1 (both values at 20° C.). Using both frequencies enables director reorientation in both directions, parallel and perpendicular to the experienced electric field, as electric field components of low and high frequencies are applied. When the dielectric anisotropy is positive the directors reorient toward the electric field; when the dielectric anisotropy is negative the directors reorient perpendicularly to the experienced electric field. The most important distinctive feature of this prior art approach is that in the ground state the directors are aligned at a pretilt angle of approximately 45° with respect to the bounding plates by treating the substrates with an obliquely deposited layer of SiOx. The high pretilt angle maximizes the reorienting dielectric torque which is proportional to the pretilt angle. In this prior art configuration, director reorientation in both directions is accelerated by elevated drive signal amplitudes of corresponding drive signal frequencies. Employing this arrangement, reorientation times (optical power change times) of 400 ms are achieved which is approximately one order of magnitude faster compared to simple TLCL designs. However, providing the distinctive pretilt alignment angle of 45 degrees is a very complicated process and costly to produce. The high ground state pretilt alignment of the LC director leads to a phase loss in comparison with the low-pretilt geometries. Such a TLC lens is very sensitive to structure geometry reducing production yields. A 300 um aperture TLCL has little use in miniature digital cameras for mobile telephone applications which require an aperture an order of magnitude higher for use with a high megapixel image sensor.

Commonly assigned International Patent Application WO 2010/022080 entitled “In Flight Autofocus System and Method” claiming priority from U.S. 61/089,821 filed 18 Aug. 2008, both of which are incorporated herein by reference, describe the use of a dual frequency liquid crystal layer in a TLCL employing a physical electric field spatial modulation structure. The structure imparts spatial modulation to each electric field component applied by a pair of drive signals characterized by frequencies across the crossover frequency. The superposition/combination of the spatially modulated electrical field components is employed to spatially modulate the orientation of the LC molecules across the aperture. The structurally imposed spatial modulation to all electrical fields, while providing some desirable optical power change characteristics, is less efficient in changing or erasing a lensing effect.

Most auto-focusing algorithms employed in handheld digital cameras require at least one up-and-down cycle in optical power in acquiring focus. There is a general need to improve auto-focusing speed. A mechanism is needed for accelerating TLC lens optical power change between low optical power and high optical power states.

### SUMMARY

It has been discovered that a hysteresis exhibited by dual frequency liquid crystal materials can be exploited in a tunable liquid crystal lens optical device to provide improved optical property variation speeds, such as for example improved optical power change speeds in transitioning between low optical power and high optical power states.

It has been further discovered that faster auto-focus acquisition may be achieved by employing continuous TLCL excitation control in accordance with a scheme driving of the TLCL under excitation conditions in both optical power change directions.

In accordance with an aspect of the invention there is provided, a tunable optical device having a layered structure comprising: a liquid crystal layer including a dual frequency liquid crystal material exhibiting a dielectric anisotropy about a crossover frequency at a corresponding temperature; a pair of liquid crystal orienting layers sandwiching the liquid crystal layer therebetween to form a liquid crystal cell, each of the orienting layers including a coating rubbed in a predetermined direction to induce liquid crystal molecular alignment at a low pretilt angle in a ground state; and an electrode structure defining an aperture and a first transparent electrode layer, the electrode structure and the electrode layer sandwiching the liquid crystal cell; the tunable optical device further having a control drive signal circuit coupled to simultaneously provide a first drive signal component of a frequency lower than the crossover frequency and a second drive signal component of a frequency higher than the crossover frequency to the electrode structure.

In accordance with another aspect of the invention there is provided, a camera lens assembly employing the tunable liquid crystal lens.

In accordance with a further aspect of the invention there is provided, a camera module employing the tunable liquid crystal lens, the camera module further comprising an image sensor and at least one image acquisition component.

In accordance with a further aspect of the invention, there is provided a method of operating a tunable liquid crystal optical device having a liquid crystal layer and an electrode structure, the liquid crystal layer including a dual frequency liquid crystal material exhibiting a dielectric anisotropy about a crossover frequency, the electrode structure sandwiching the liquid crystal layer, the method comprising: applying to the electro structure a first drive signal component having a frequency below the crossover frequency at a first amplitude and a second drive signal component having a frequency above the crossover frequency at a second amplitude, such that liquid crystal molecular directors in the liquid crystal layer are excited by a differential of the first and second drive signal components to cause the tunable liquid crystal optical device to express a corresponding optical property value.

In accordance with yet another aspect of the invention, there is provided an auto-focus method for acquiring focus in an imaging system using a tunable liquid crystal lens, the tunable liquid crystal lens having a liquid crystal layer and an electrode structure, the liquid crystal layer including a dual frequency liquid crystal material exhibiting a dielectric anisotropy about a crossover frequency, the electrode structure sandwiching the liquid crystal layer, liquid crystal molecular directors in the liquid crystal layer being excited by a differential of first and second drive signal components simultaneously applied to the electrode structure to cause the tunable liquid crystal lens to express a corresponding optical power value, the first drive signal component having a frequency below the crossover frequency at a first amplitude and the second drive signal component having a frequency above the crossover frequency at a second amplitude, the method comprising: changing either one of the first and second drive signal components to cause a change in optical power between low and high optical powers in absolute terms in a corresponding one of a positive and negative direction; obtaining a focus score; determining parameters for the drive signal components to cause the focus score to change; and repeating the method.

In accordance with a further aspect of the invention, there is provided a tunable liquid crystal optical device having a dual frequency liquid crystal material exhibiting a dielectric anisotropy about a crossover frequency wherein liquid crystal molecule directors are attracted to an electric field applied to the liquid crystal layer via a drive signal component of a first frequency on one side of the crossover frequency, and repulsed by the electric field applied via a drive signal component of a second frequency on another side of the crossover frequency. An electric field source controlling the liquid crystal is configured to operate substantially simultaneously using frequencies on opposed sides of the crossover frequency to subject the liquid crystal molecules to a combination of attraction and repulsion forces.

### BRIEF DESCRIPTION OF THE DRAWINGS

The invention will be better understood by way of the following detailed description of embodiments of the invention with reference to the appended drawings, in which:

FIG. 1 is a schematic diagram showing a prior art tunable liquid crystal lens device;

FIG. 2 is a schematic diagram showing another prior art tunable liquid crystal lens device;

FIG. 3A is a schematic diagram showing a yet another prior art tunable liquid crystal lens device;

FIG. 3B is a schematic diagram showing the effect of the tunable liquid crystal lens device of FIG. 3A on an incident light wavefront under different drive signal conditions;

FIG. 3C is a schematic diagram showing optical power variation for the tunable liquid crystal lens device of FIG. 3A under the drive signal conditions shown in FIG. 3B;

FIG. 4A is a schematic diagram showing a variation of real and imaginary components of the dielectric permittivity tensor of dual frequency liquid crystal material MLC2048 from EM Industries at 24° C.;

FIG. 4B is a schematic diagram showing a dielectric properties of MLC2048 subjected to a frequency of 20 kHz as a function of temperature;

FIG. 5A is a schematic diagram illustrating a tunable liquid crystal lens layered structure in accordance with the proposed solution;

FIG. 5B is a schematic diagram illustrating another tunable liquid crystal lens layered structure having a variable conductivity layer geometry in accordance with the proposed solution;

FIG. 5C is a schematic diagram illustrating a polarization independent tunable liquid crystal lens layered structure having a common variable conductivity layer in accordance with the proposed solution;

FIG. 6A is a schematic diagram illustrating an equipotentials distribution for a tunable liquid crystal lens subjected to a drive signal having a moderate frequency in accordance with the proposed solution;

FIG. 6B is a schematic diagram illustrating another equipotentials distribution for a tunable liquid crystal lens subjected to another drive signal having a low frequency in accordance with the proposed solution;

FIG. 7 is a schematic diagram illustrating a variation of real components of the dielectric permittivity tensor the dual frequency liquid crystal material MLC2048 from Merck at 45° C.;

FIG. 8A is a schematic diagram showing a tunable liquid crystal lens employing a dual frequency liquid crystal material driven by a low-voltage low-frequency drive signal to align the liquid crystal molecules in accordance with the proposed solution;

FIG. 8B is a schematic diagram showing a tunable liquid crystal lens employing a dual frequency liquid crystal material driven by a drive signal having a frequency below a crossover frequency at Δ∈>0 in accordance with the proposed solution;

FIG. 8C is a schematic diagram showing a tunable liquid crystal lens employing a dual frequency liquid crystal material driven by a dual frequency drive signal having a low frequency component below a crossover frequency at Δ∈>0 and a high frequency component above the crossover frequency at Δ∈<0 in accordance with the proposed solution;

FIG. 9 is a schematic diagram showing a variation of a tunable liquid crystal lens optical property with a drive signal having dual root means square voltage amplitude components at corresponding fixed frequencies 1 kHz, Δ∈>0 and 30 kHz, Δ∈<0 in accordance with the proposed solution;

FIGS. 10A and 10B are a schematic diagrams illustrating measured variability in dynamic transitions of a tunable dual frequency liquid crystal lens optical property with drive signal root means square voltage amplitude at constant frequency;

FIG. 11 is a schematic diagram showing another embodiment of a tunable liquid crystal lens structure employing a dual frequency liquid crystal in accordance with the proposed solution;

FIG. 12 is a schematic functional diagram showing interconnected tunable liquid crystal lens control components of an optical system providing auto-focus functionality in accordance with the proposed solution;

FIG. 13 is a schematic view of a tunable LC lens structure having a frequency dependent material layer and a hole patterned top electrode located near the top of the layer, in accordance with a variant embodiment of the proposed solution;

FIG. 14 is a schematic view of a tunable LC lens structure in which a gradient control structure has a hole patterned electrode and frequency dependent material sandwiched between two LC cells, in accordance with a further variant embodiment of the proposed solution;

FIG. 15 illustrates a prior art liquid crystal lens design using a uniform planar upper electrode, a segmented, four-quadrant electrode placed below the upper electrode, and a bottom uniform planar electrode on a bottom of a liquid crystal cell;

FIG. 16A illustrates a side sectional view of a tunable liquid crystal lens with an inset top view of a segmented top electrode according to an embodiment in which a frequency dependent material is above the segmented, hole patterned electrode;

FIG. 16B illustrates a side sectional view of a tunable liquid crystal lens with an inset top view of a segmented top electrode according to an embodiment in which a frequency dependent material is within the aperture of the segmented, hole patterned electrode;

FIG. 16C illustrates a side sectional view of a tunable liquid crystal lens with an inset top view of a segmented top electrode according to an embodiment in which a frequency dependent material is below the segmented, hole patterned electrode; and

FIGS. 17A to 17E illustrate quasistatic control of a four segment hole patterned electrode providing an arbitrary direction of optical axis tilt between 0 deg and 45 deg,

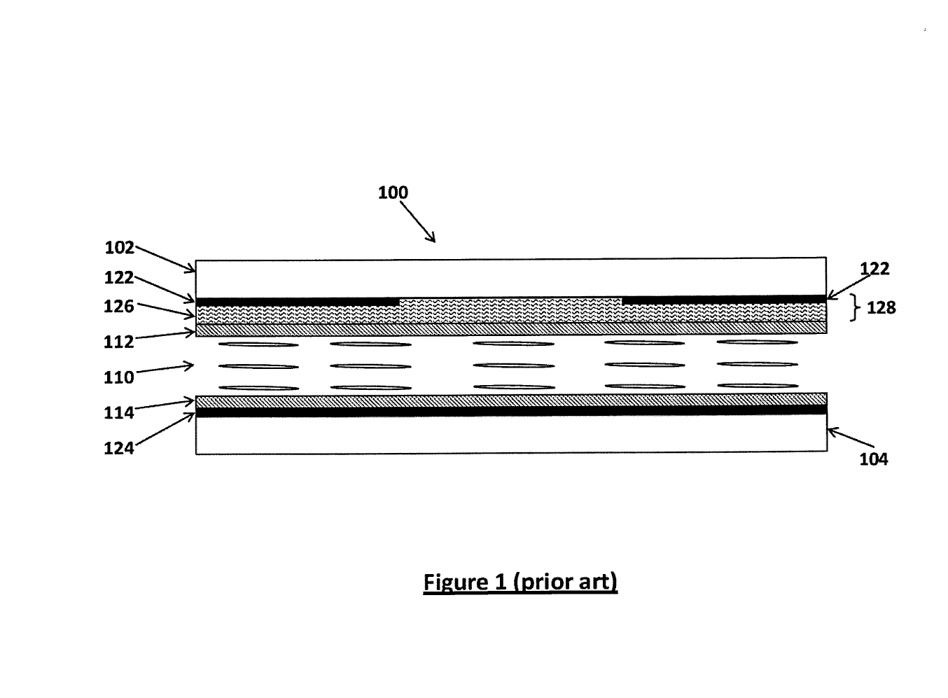

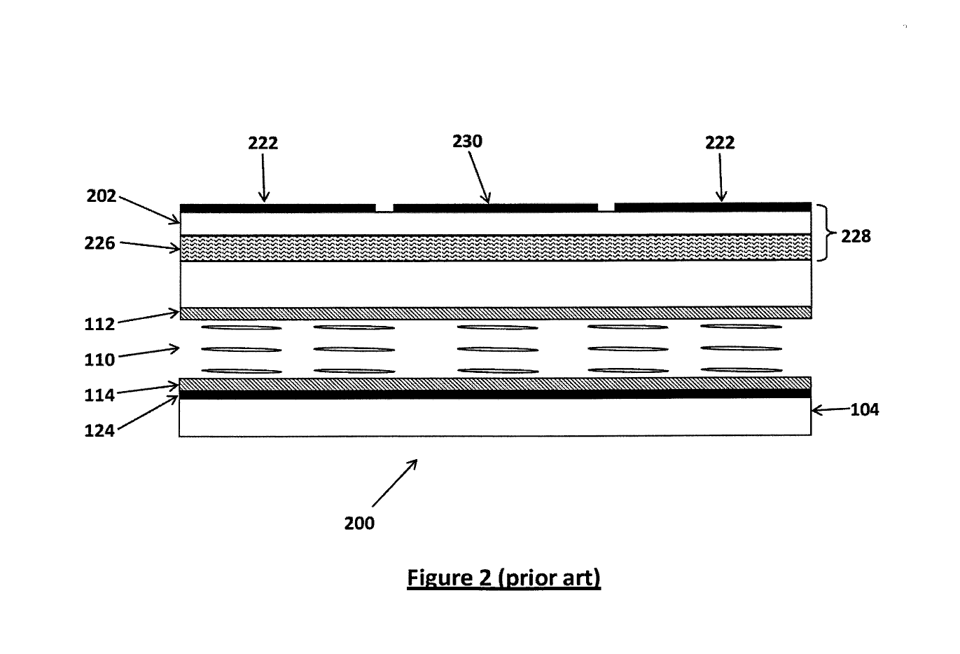

wherein similar features bear similar labels throughout the drawings. While the layer sequence described is of significance, reference to “top” and “bottom” qualifiers in the present specification is made solely with reference to the orientation of the drawings as presented in the application and do not imply any absolute spatial orientation.

### DETAILED DESCRIPTION

### Tunable Liquid Crystal Lens Structure

In accordance with an aspect of the proposed solution, a variable optical device is provided for controlling the propagation of light passing therethrough.

### R_s Gradient Softening

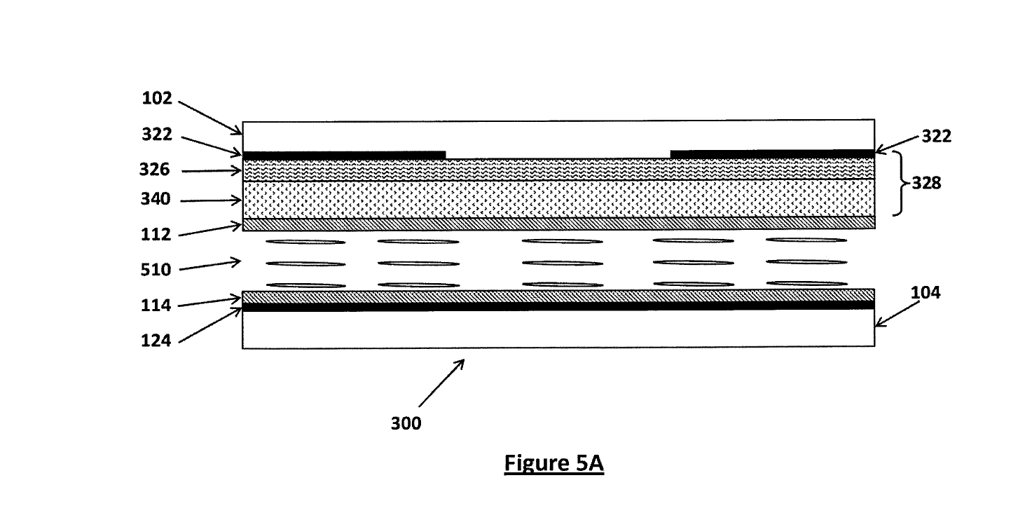

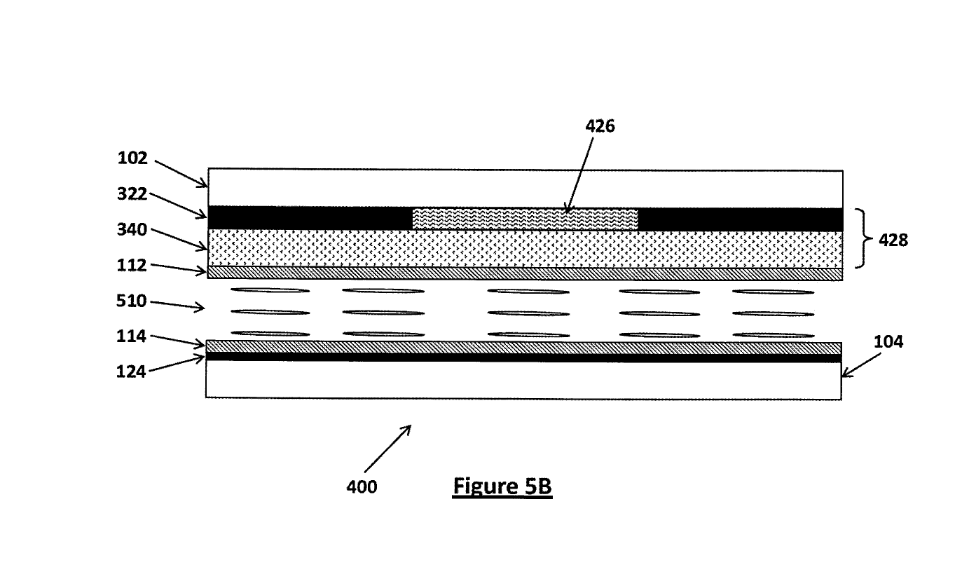

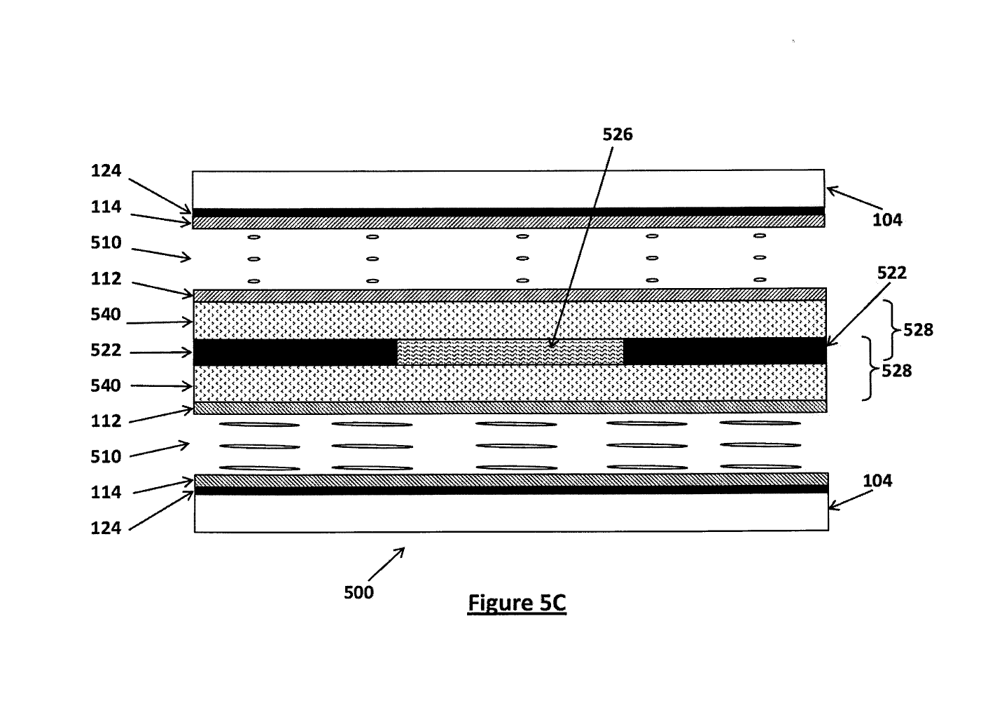

FIG. 5A shows a single polarization Tunable Liquid Crystal Lens (TLCL) structure in accordance with the proposed solution. TLCL 300 has an electric field shaping control (layer) substructure 328 including a top fixed hole-patterned conductive ring electrode 322 forming an aperture on top of a Weakly Conductive Layer (WCL) 326 separated from the LC layer 510 by a buffer layer 340. The WCL 326 is either in direct physical contact with the top hole-patterned ring electrode 322 or in electrical contact therewith subject to manufacturing considerations including choice of specific layer materials (not all layer materials bond to each other). The electrical contact provided between the top hole-patterned electrode 322 and the WCL 326 enables the TLCL 300 to employ only two electrodes 322 and 124. Therefore, TLCL 300 requires a single drive signal minimizing complexity of drive signal generation and control electronics. The top hole-patterned electrode 322, without limiting the invention, can be made of Al. Other low resistance electrode compositions may be employed, such material selection depending on manufacturing factors familiar to persons of skill in the art of wafer fabrication.

In accordance with the proposed solution, buffer layer 340 reduces the sensitivity of the TLCL to LC cell thickness. In accordance with one implementation of the proposed solution, the thickness of buffer layer 340 provides a “buffer spacing” between the WCL 326 and the LC 510, geometry which softens the gradient of the electric field applied. In accordance with another implementation of the proposed solution, “dielectric properties” of the buffer layer 340 softens the gradient of the electric field applied. The invention is not limited to the above examples of buffer layers 340, it is envisioned that in practice buffer layer 340 would be configured to employ a combination of layer thickness and material properties to soften the gradient. It is envisioned that the buffer layer 340 may also be configured to provide properties typically required of a top substrate of the TLCL 300 structure. For example, buffer layer 340 can include optically transparent (dielectric) materials not limited to polymers, ceramics, etc.

In accordance with the proposed solution, FIG. 5B illustrates another implementation of tunable liquid crystal lens. TLCL 400 includes a two tier electric field shaping control layer 428. The buffer layer 340 forms a bottom tier immediately adjacent to a variable conductivity layer formed by the top hole-patterned conductive electrode 322 having an aperture and a weakly conductive layer 426 filling the aperture in the center of the hole-patterned electrode 322. The buffer layer 340 softens the gradient of the electric field applied to the LC 510.

### Full TLCL

While FIGS. 5A and 5B describe TLC optical device structures configured to control light propagation, such light propagation control is provided only for a single light polarization. Such TLC optical device structures are said to be polarization dependent and referred to as half TLCL. For operation in natural lighting conditions (sun, lamp), two cross-oriented LC cells are required to control light propagation for two orthogonal polarizations of incident light to provide a polarization independent TLCL.

Prior art optical device geometries proposed by Naumov require the use of two high resistivity layers, which will almost always have different values of R_s and thus the two orthogonal light polarizations will typically not operate synchronously.

In accordance with another aspect of the proposed solution, a variable optical device is provided for controlling the propagation of light passing therethrough, the geometry of the variable optical device including a common variable conductivity layer employing only one weakly conductive layer for controlling two liquid crystal cells of a polarization independent optical device.

In accordance with the proposed solution, the polarization dependent geometry presented in FIG. 5B may be extended to provide a polarization independent TLCL structure. Preferably a polarization independent tunable liquid crystal lens for a digital camera is configured to control light propagation for two orthogonally polarized incident light beam components employing a mirrored TLCL structure, referred to as full TLCL.

With reference to FIG. 5C, TLCL structure 500 has a variable conductivity layer including a common hole-patterned mid conductive electrode 522 forming an aperture and a common weakly conductive layer 526 filling the aperture in the center of the common hole-patterned electrode 522. A pair of top and bottom electric field shaping control layers 528 share the variable conductivity layer, each layer 528 employing a respective top and bottom buffer layer 540. Remaining layers are present in mirror fashion about the mid variable conductivity layer shown bearing similar labels according to the functionality provided (qualified by top and bottom identifiers herein below). The central variable conductivity layer is positioned between two LC layers 510.

Each one of the two liquid crystal layers 510 employed may be said to have a different LC director orientation as do orienting coatings 112 and 114. Preferably, the two LC layers 510 have directors in substantially orthogonal planes. For example, with the normal of the TLCL layered structure 500 designated as the Z axis, one of the directors might be in the XZ plane while the second director being in the YZ plane.

In accordance with a preferred embodiment, the same WCL 526 is being employed simultaneously for controlling both LC cells. Not only is the TLCL 500 polarization independent, also the focusing of both orthogonal polarizations of the incident natural light is substantially synchronized. In addition, small cell gap variations do not significantly affect overall performance as buffer substrates 540 soften such dependence.

Electrodes 124, to which the drive signal is provided, are located, respectively, adjacent to each LC layer 510, away from the central variable conductivity layer and therefore away from the common hole-patterned conductive electrode 522.

For ease of description of the following TLC functionality, an abstraction of control electrode structures providing spatial shaping of the driving electric field is made by referring to the electric field shaping control layer 328/428/528. For ease of description, reference to structural elements is made with respect to the half TLCL implementation shown in FIG. 5B. However, the invention is not limited to the implementation shown in FIG. 5B, the functionality described hereinbelow applies to other implementations of the proposed solution such as, but not limited to, those shown in FIGS. 5A and 5C. Preferred implementations include full TLC lens structures 500 illustrated in FIG. 5C.

### Operational Characteristics

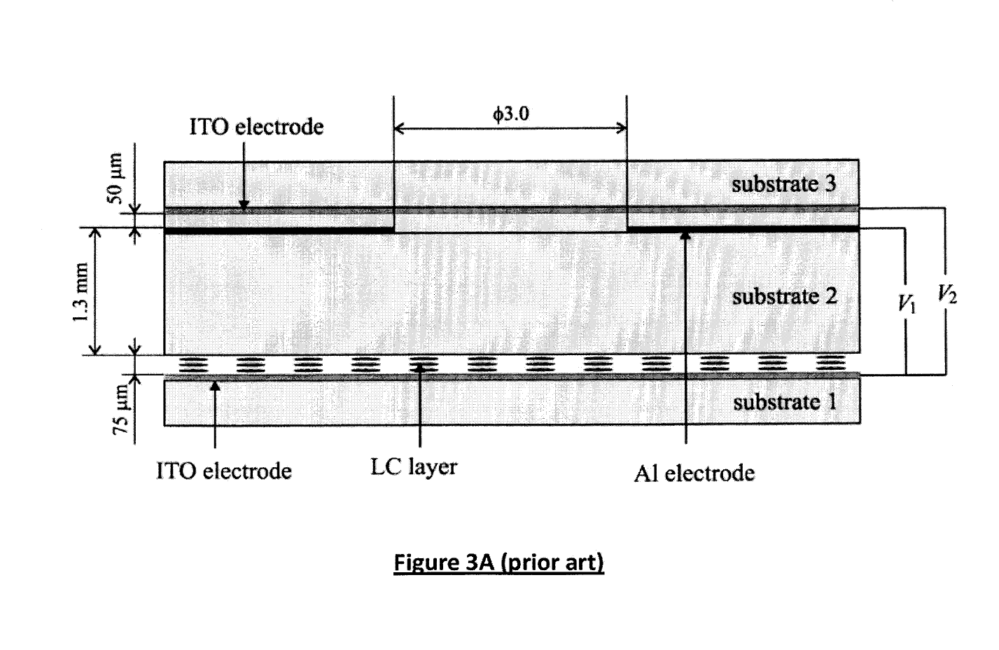

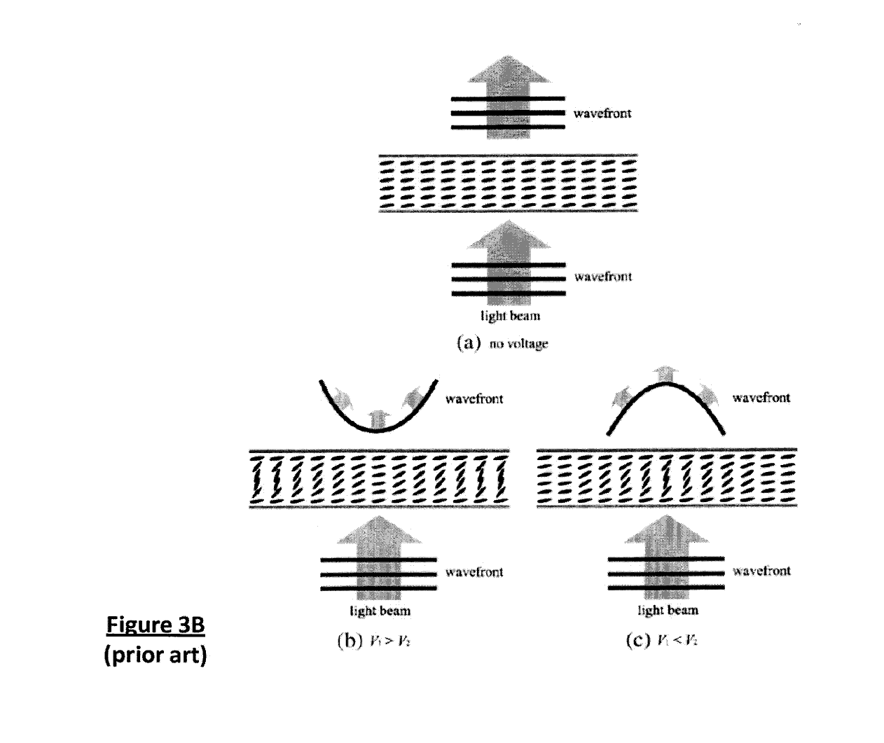

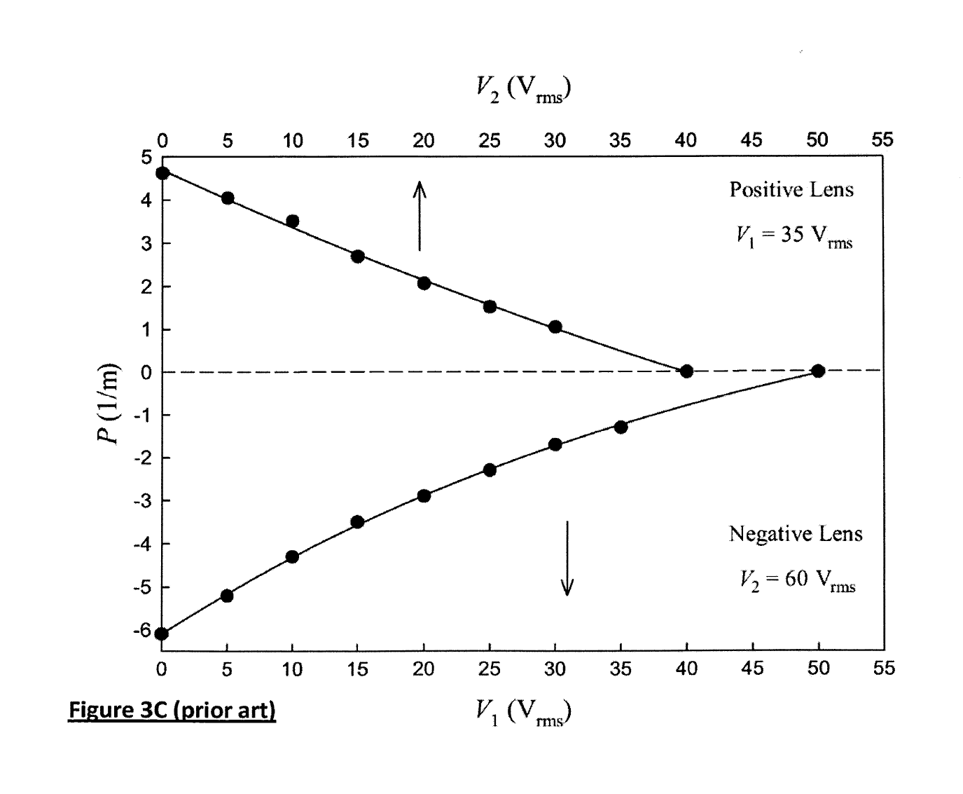

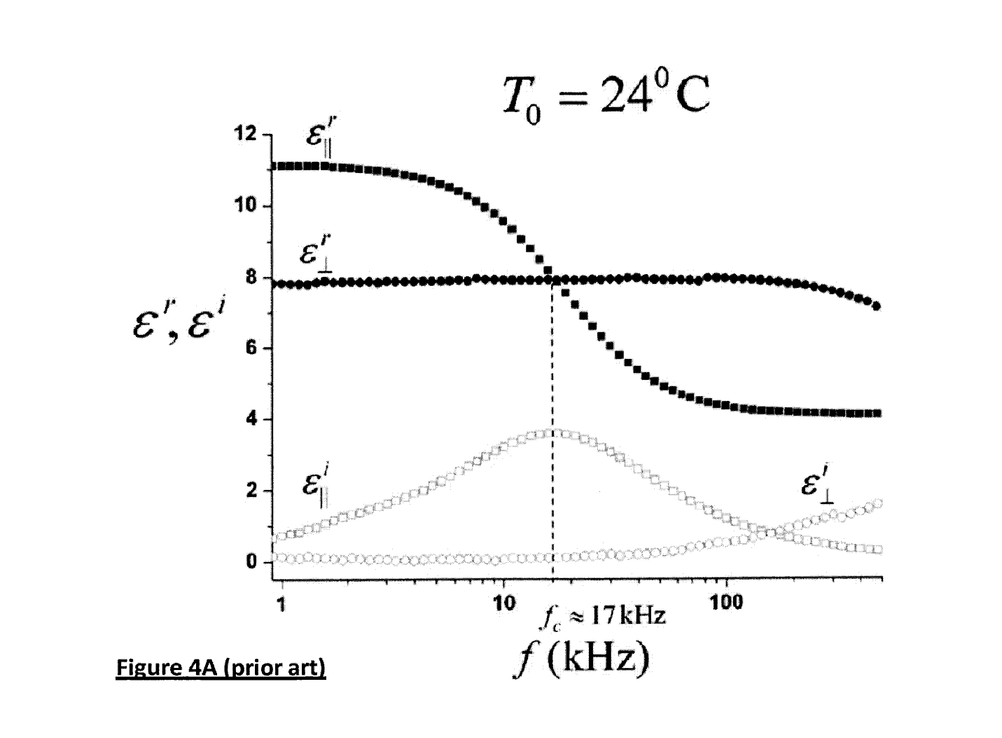

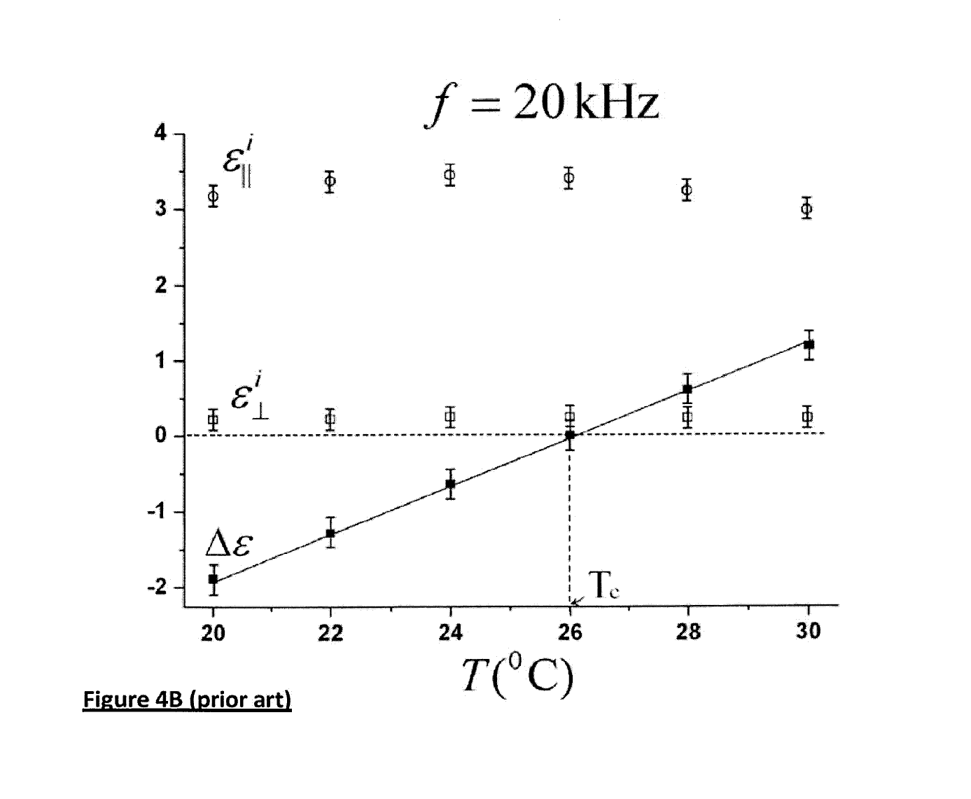

Tuneability of TLC lenses may be achieved through various drive signal modes, divided for ease of description herein, into: application of a variable voltage drive signal (fixed frequency amplitude modulation), and application of drive signals having a frequency and an amplitude. References are also made herein to applying a drive signal having a “variable frequency at fixed voltage” (frequency modulation). A person of ordinary skill in the art would understand references to the “fixed voltage” in the context of a drive signal having a frequency, as the Root Means Square (RMS) voltage amplitude of the drive signal (Vrms). For example, the prior art attempt illustrated in FIGS. 3A to 3C show variable voltage fixed frequency (amplitude modulation) drive.

The proposed solution is further directed to a variable Tunable Liquid Crystal (TLC) optical device configured to control the propagation of light passing therethrough by employing a dual fixed frequency drive signal having corresponding variable amplitudes. Complex electric field profile shaping is provided, for example.

### Frequency Control

In accordance with a further aspect of the proposed solution, a variable optical device controlling the propagation of light passing therethrough makes use of a frequency dependent material and an electrical signal generator generating a drive signal at a plurality of frequencies and amplitudes to modify a spatial profile of the electric field. Frequency signal generators are known, and only limited details are provided herein with respect to employing such a frequency signal generator to implement a TLCL control component of a tunable optical system.

In accordance with an implementation of the proposed solution, the control signal for tuning the tunable liquid crystal lens (TLCL) 400 is provided by a dual frequency control signal circuit configured to cause the TLC lens 400 to tune the focus of an incident image as a function of at least two variable amplitude drive signal of fixed frequencies.

### Modified Weakly Conductive Layer

In accordance with an embodiment of the proposed solution, TLCL 400 employs a weakly conductive layer 426 including a frequency dependent material therein and frequency control to provide further significant improvements in optical power change speeds and consequently in auto-focus acquisition times. The frequency dependent material enables the WCL 426 to function as a frequency-responsive electric field gradient control layer by shaping the electric field applied to (and experienced) by the LC layer 510. Frequency control is provided by a variable frequency control drive signal circuit configured to cause the TLCL 400 to control light propagation as a function of control drive signal frequency at a selected corresponding RMS voltage amplitude (Vrms). An electrical signal generator generates drive signal components at a plurality of different frequency and voltage combinations and supplies combined drive signal to the electrodes of the TLCL 400 so as to generate an electric field across LC layer 510.

The material properties of the variable conductivity layer are such that supplying an Alternating Current (AC) drive signal leads to a spatially modulated electric field. With reference to FIG. 5B, the electric field may have a portion substantially defined by the fixed hole-patterned conductive electrode 322, and a portion defined by the frequency dependent material in the weakly conductive layer 426.

The frequency dependent material of the WCL 426 interacts with the electric field and therefore affects the shape the electric field otherwise present between conductive electrodes 124 and 322. For ease of description, however without limiting the invention, the frequency dependent material may include a high dielectric constant material. Functionally, the frequency dependent material of this example has the characteristic of allowing a limited degree of charge mobility therethrough.

The frequency dependent material has a charge mobility which is dependent on the drive signal frequency causing a spatial profile of the electric field to vary as a function of drive signal frequency. Periods of time available for charge to flow within the frequency dependent material are longer at low frequencies which results in higher charge mobility. Similarly, at higher frequencies at the same Vrms amplitude, the electric potential in each positive or negative cycle is applied for shorter periods of time, and the resulting charge flow within the frequency dependent material is correspondingly greatly reduced. Thus “charge mobility” is used to refer to the overall ability of electric charge to penetrate within the frequency dependent material present in the aperture of the hole patterned electrode within the constraints of the alternating electric drive signal applied. Without loss of generality, for the reminder of the description herein, the weakly conductive layer 426 will be referred to as the frequency dependent layer 426.

### Equipotentials

The frequency dependent layer 426 is employed to dynamically create an effective electrode profile.

With reference to the layered structure of FIG. 5B, a drive signal applied between the hole-patterned electrode 322 and the flat electrode layer 124 will, in the absence of any significant charge mobility in the frequency dependent layer 426, create a non-uniform electric field across the LC layer 510. This non-uniform field can, for example, give a lensing profile to LC layer 510 of a particular characteristic as described hereinabove.

For example, electric field shaping is dependent on the frequency of the drive signal, which determines the extent of charge penetration into the frequency dependent layer 426. At a high frequency, corresponding to low charge mobility, the geometry of the hole-patterned electrode 322 has a greater contribution to the way in which the gradient control layer shapes the electric field. However, at a low frequency, corresponding to high charge mobility, the frequency dependent layer 426 creates an effective electrode surface, and the electric field shaping control layer 428 shapes the electric field according to the overall electrode geometry resulting from hole-patterned electrode 322 and the frequency dependent layer 426.

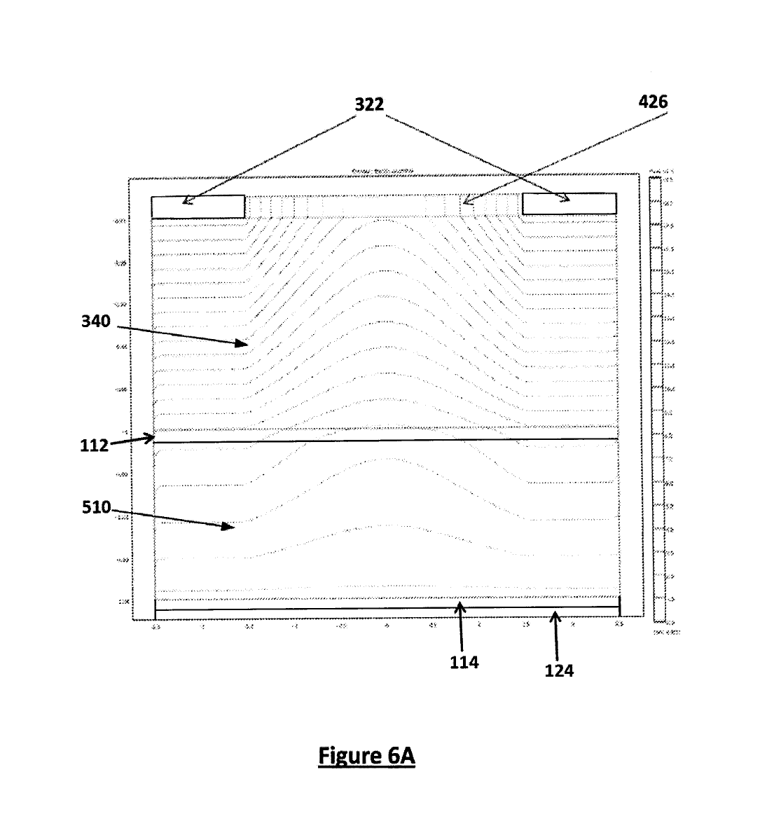

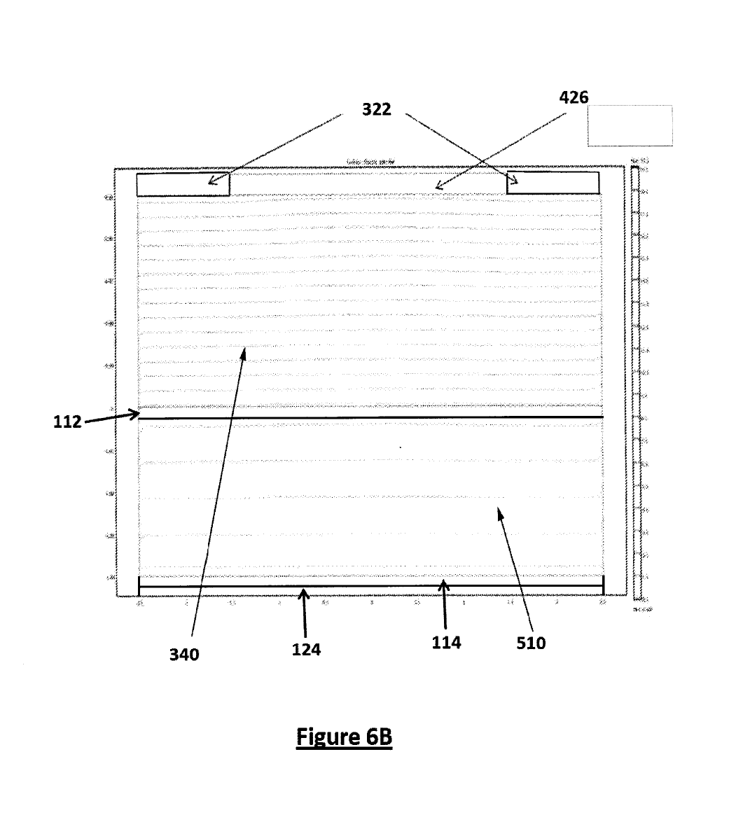

For example, FIGS. 6A and 6B illustrate corresponding equipotential planes for the layered geometry illustrated in FIG. 5B. As shown, in FIG. 6A, the use of a moderately high driving signal, for example 30 kHz at 30 Vrms, creates a moderate amount of charge movement in the frequency dependent layer 426 which generates a particular electric field, shown as having a smooth gradient. The active frequency range depends upon the characteristics of the frequency dependent material and the Vrms amplitude used.

However, when the driving signal applied has a low frequency for which there is a significant amount of charge mobility in the frequency dependent layer 426, the charge penetration into the frequency dependent layer 426 creates an effective electrode structure extending into the aperture in the center of the hole-patterned electrode 322. An effective electrode is created which is substantially flat across the entire structure. This “horizontal” extension of the hole-patterned electrode 322 changes the electric field profile to be uniform as a result of the two effectively uniform electrode structures 322-426 and 124. This uniform field has a uniform orienting effect on the liquid crystal molecules so that any lensing effect is erased.

As shown in FIG. 6B, the use of a relatively low frequency driving signal, for example 1 kHz at 20 Vrms, results in greater charge penetration into the frequency dependent layer 426. This flattens the electric field profile, introducing correspondingly uniform LC molecular reorientation. The flat equipotential surfaces correspond to a flat electric field across the diameter of the lens. Here also, the “low” frequency range depends upon the characteristics of the frequency dependent material used.

It has been discovered that the use of relatively low frequency drive signals reduces disclinations (orientation defects). Use of flat electric field profiles provided by low frequency drive signals allows the “erasure” of a lens. Therefore lens erasure may be provided at low frequency and low RMS voltages without necessitating a third electrode (see Sato et al. herein above) or a drastic change in the driving voltage to very low (e.g., 0 Volts) or very high voltages (e.g., 100 Volts), which tend to reduce TLCL performance or violate voltage limits of a host device, such as a mobile telephone.

### Dual Frequency Nematic Liquid Crystal Layer

It has been discovered that the use in a TLCL of a Dual Frequency nematic Liquid Crystal (DF-LC) subjected to a spatially modulated electric field generated by a drive signal having at least two amplitude modulated drive signal components with frequencies, one at positive delta epsilon and the other at negative delta epsilon, provides a TLCL continuously operable under excitation conditions while changing optical power in either direction.

With reference to FIGS. 5A to 5C the Liquid Crystal (LC) cell layer 510 is filled with a DF-LC material, such as but not limited to MLC2048 from Merck, exhibiting a dielectric anisotropy. The invention is not limited to a liquid crystal layer filled with DFLC, employing a lower proportion of DFLC is possible. In contrast to Pishnyak-Sato-Lavrentovich above, layer 510 is bounded by the same low pretilt-angle alignment layers 112/114, for example at 3 degrees. The use of low pretilt alignment layers 112/114 benefits from simple manufacture and robust design.

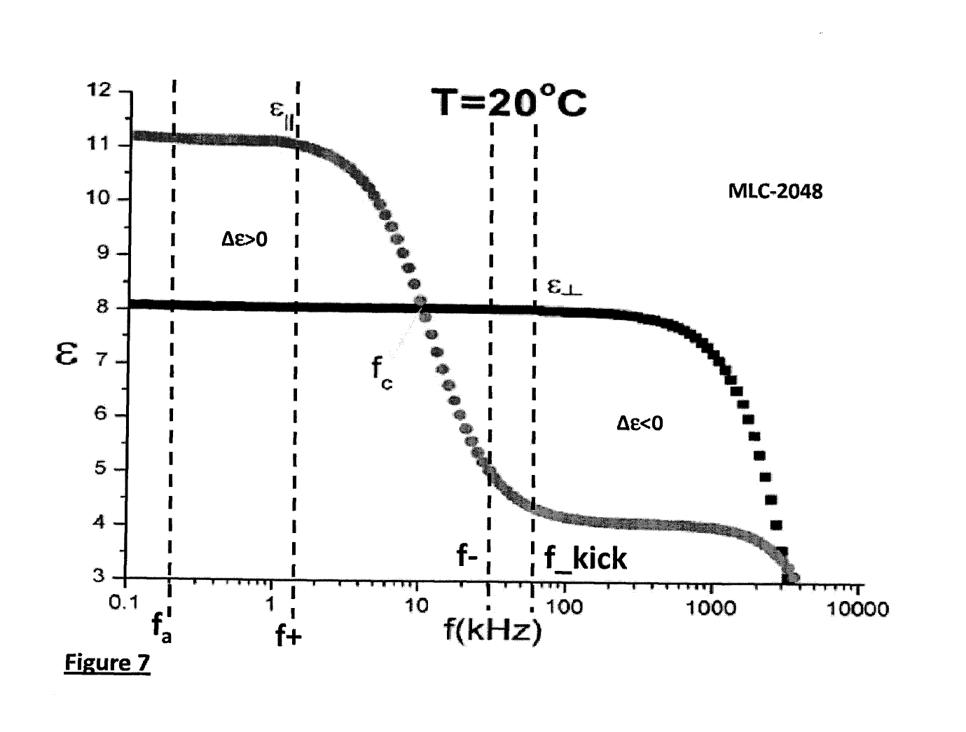

With reference to FIG. 7, by applying an electrical field generated by at least two fixed frequency drive signal components, one on each side of the crossover frequency along the dielectric anisotropy curve, excitation drive is provided for both reorientation directions. The DFLC molecules can be driven rapidly in both reorientation directions—turned on by a drive signal having a frequency below f_c at which Δ∈>0 and turned off by a drive signal having a frequency above f_c at which Δ∈<0, providing optical power change acceleration.

### Example TLCL Structure

By way of a non-limiting example and with reference to FIG. 5B, dimensions (geometry) of a variable-focus flat refractive TLC lens implemented in accordance with the proposed solution are provided. It will be appreciated that the dimensions can vary greatly depending on geometry and choice of materials:

The substrate 104 can be made of glass with a thickness of 50 to 100 microns. Substrate 102 can also be made of glass. Top and bottom alignment layers 112/114 can include Polyimide layers about 20 to 40 nm thick that are rubbed to yield surfaces that induce a liquid crystal ground state alignment with a low pre-tilt angle, for example 3 degrees. The liquid crystal layer 510 filled with MLC2048 can be 5 to 30 microns thick, as an example. With spatial modulation, such a single liquid crystal layer 510 forms a gradient index lens which focuses a single linear polarization of incident light.

The hole-patterned electrode 322 can be made of an opaque metal such as Aluminum (Al), or it can be made of Indium Tin Oxide (ITO) which is transparent. The thickness of the hole-patterned electrode 322 can be in the range of 10 to 50 nm. Without limiting the invention, the hole-patterned electrode layer 322 can also be substantially optically hidden and thus would not interfere with the propagation of light through the optical device.

The weakly conductive layer 426 can have a thickness of about 10 nm. The frequency dependent (permittivity or complex dielectric) material of the WCL 426 can comprise a variety of materials such as, but not limited to, titanium oxide. Titanium oxide has semiconductor properties that change with applied drive signal frequency.

The TLC lens can be refractive or diffractive.

In the embodiment of FIG. 5C, a hole-patterned electrode 522 and frequency dependent material 526 form a variable conductivity layer shared between two LC layers 510. A two LC layer TLCL can be assembled in this manner to have a lens diameter of about 1 to 3 mm within a layered structure 500 having a thickness of about 460 microns.

### DF-LC TLCL in Operation

At zero frequency and zero Vrms amplitude, the LC layer 510 is governed by the orienting layers 112 and 114. LC molecules are substantially aligned, for example at 3 degrees. The index of refraction of the LC layer 510 has no variability across the aperture. No lensing is provided by the LC layer 510, and therefore the TLCL 400 provides zero optical power. This unpowered (U-LOP) ground state illustrated in FIG. 5B is a passive state governed by the physical properties of the geometry. At very low angles, for example lower than 4 degrees, little torque is applied to the LC molecules by the electric field, and the response has nonlinear effects as a lens is formed. Some LC molecules form alignment domains (disclinations) which can lead to drastic index of refraction variability before charge mobility takes over.

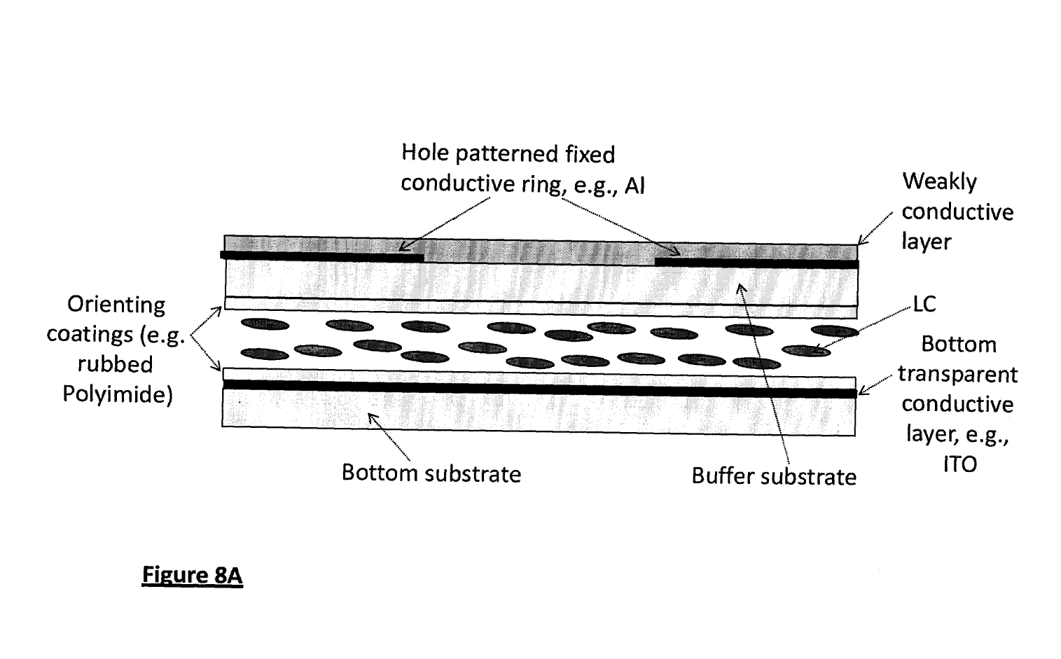

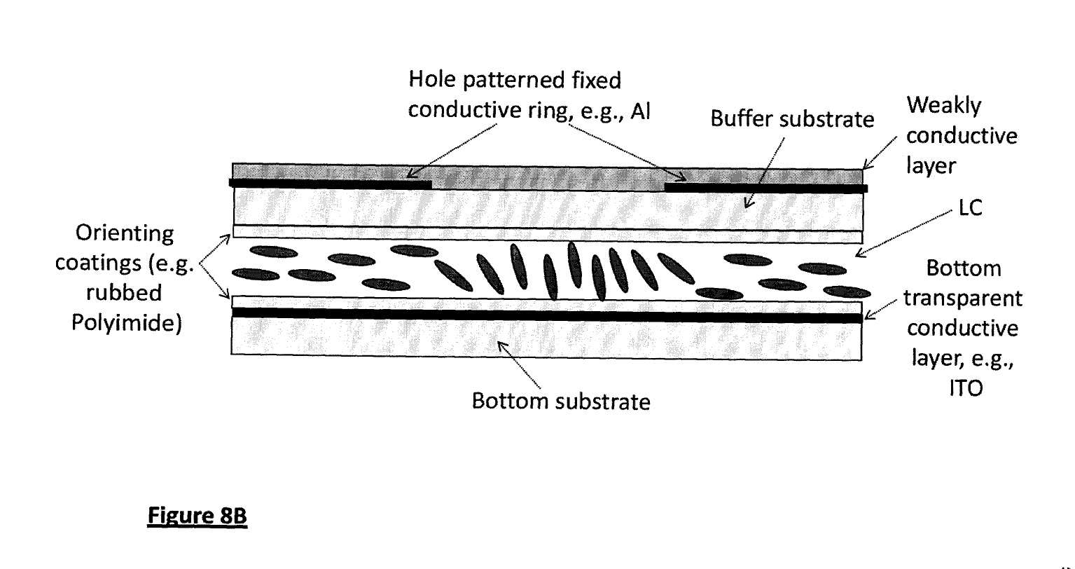

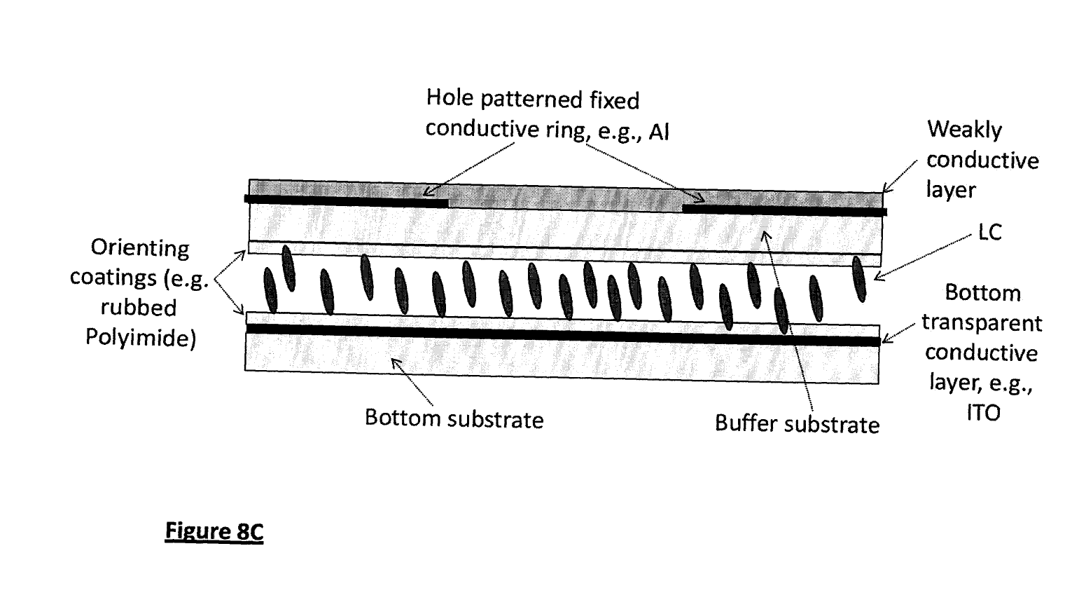

FIG. 8A illustrates a tunable LC lens, having a geometry similar to that illustrated in FIG. 5B. For a given (low) Vrms amplitude beyond an empirically determined threshold, an initial application of a relatively low frequency f_a drive signal creates an effective uniform electrode profile as charge penetrates a great deal across (into) the aperture. A corresponding uniform electric field profile, created due to extensive charge penetration into the frequency dependent layer 426, lifts LC molecules across the LC layer 510 out of the unpowered ground state to have an initial excitation orientation. The LC molecules will all be reoriented to have a common angular orientation, for example 10 to 15 degrees instead of the pre-tilt angle of about 3 degrees. As described herein above, LC molecules having a common angular orientation, results in an LC layer 510 having a low refractive index variability, substantially no lensing is provided by the LC layer 510, and therefore the TLCL 400 has negligible optical power. This state is an excited state governed by the properties of the variable conductivity layer including electrode 322 geometry and frequency dependent layer 426 charge mobility as described herein above. This initial excitation state frequency f_a is shown in FIG. 7 and may vary with material properties of the frequency dependent layer, Vrms and TLCL geometry. As an example, for low Vrms amplitudes a usable low frequency f_a can be as low as 100 Hz.

A drive signal component of frequency f+, for example 1 kHz having an amplitude preferably between 14 to 40 Vrms, more specifically between 20 to 36 Vrms, is employed to operate the DF-LC TLCL 400. This low frequency drive signal component contributes a flat electrical field component to (raise) lift molecules following initial excitation. It has been found that, simultaneously driving the DF-LC TLCL 400 with a second drive signal component of frequency f−, for example 30 kHz having an amplitude preferably between 5 to 50 Vrms, more specifically between 10 to 50 Vrms, improved TLCL driving conditions can be provided. This high frequency drive signal component contributes a spatially modulated electrical field component to (lower) depress molecules.

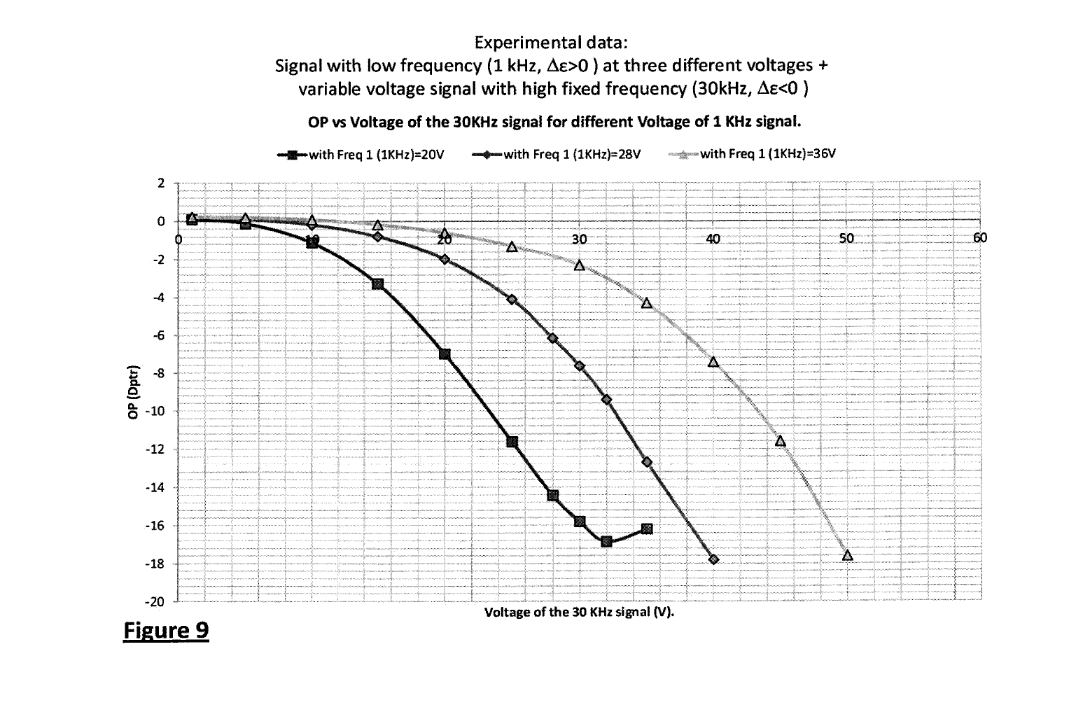

With reference to FIG. 9, showing the DF-LC TLCL response to the combined drive signal, when the high frequency drive signal component competes with the low frequency drive signal component, a non-uniform profile of the electric field develops across the LC layer 510 and the LC molecules have a non-uniform angular orientation. In turn the variability of the refractive index across the LC layer 510 is non-uniform and the LC layer 510 provides a corresponding lensing effect. In the context of TLCL 400, FIG. 9 depicts experimentally verified attainable optical powers. As described herein, as the Vrms amplitude of the drive signal component increases, charge penetration into the frequency dependent layer 426 gives the electric field a corresponding profile illustrated in FIG. 8B. Surprisingly, since all of the LC molecules were pre-aligned by the application of the low frequency f_a, no disclinations occur (persist) as the lens profile is expressed and the LC molecules efficiently respond to the electric field greatly reducing TLCL lens aberrations. While the experimental data relates to a negative lensing effect, the invention is not intended to be limited to negative optical power TLCL lenses. The invention is not limited to different f_a and f+ frequencies, a single frequency may be employed.

By changing the Vrms amplitudes and frequencies f+/f− of the combined driving signal, the profile of the electric field can be actively shaped and therefore the LC alignment profile. By appropriately choosing drive signal parameters (Vrms', f+/f−) the creation and the erasure of the lensing effect can both be performed under excitation conditions. For example, if the Vrms amplitude of the low frequency component f+ dominates the Vrms amplitude of the high frequency component f−, then the LC molecules will be actively attracted towards the electric field providing a lensing effect, however extreme dominance causes the LC molecules to uniformly align leading to no lensing effect (Optical Power=0 Diopters) as illustrated in FIG. 8C. If in contrast the Vrms amplitude of high frequency component f− dominates, then the peripheral molecules will be progressively actively repulsed to create a lens as illustrated in FIG. 8C.

Within a drive signal Vrms range, between relatively low Vrms and relatively high Vrms, the Vrms of either driving signal may be varied to provide a gradually changing optical parameter of the DF-LC layer 510 and therefore to provide a gradually changing optical power of the TLCL. The steady state optical power response is typically non-linear as illustrated in FIG. 9. It is emphasized that the reachable maximum optical power is a consequence of a particular TLCL geometry, particular frequency dependent material selection, particular dual-frequency liquid-crystal material selection, etc. Beyond a maximum Vrms amplitude, the applied drive signal has a choking effect on charge flow in the frequency dependent layer 426 and the shape of the electric field applied to LC layer 510 is controlled by other TLCL properties, such as but not limited to: hole-patterned electrode 322 geometry. In the case of the TLCL 400, optical power begins to weaken gradually beyond a maximum optical power. This is illustrated, for example, in FIG. 9 by increasing the Vrms amplitude of the f− drive signal beyond 30V while the f+ drive signal amplitude is 20V. Both Vrms dominant drive states are excitation states and the TLCL can achieve relatively quick optical property (optical power) transition.

While the operation of the DF-LC TLCL lens has been described with respect to a single polarization half TLCL, for example having a structure illustrated in FIG. 5B, it is understood that a full TLCL, for example having a structure illustrated in FIG. 5C can be driven in the same way to provide a full polarization TLC lens. Low alignment frequencies in the 100 Hz range and maximum optical power in the 30 kHz range advantageously place the necessary frequency generator components into the manufacturable and miniaturizable realm.

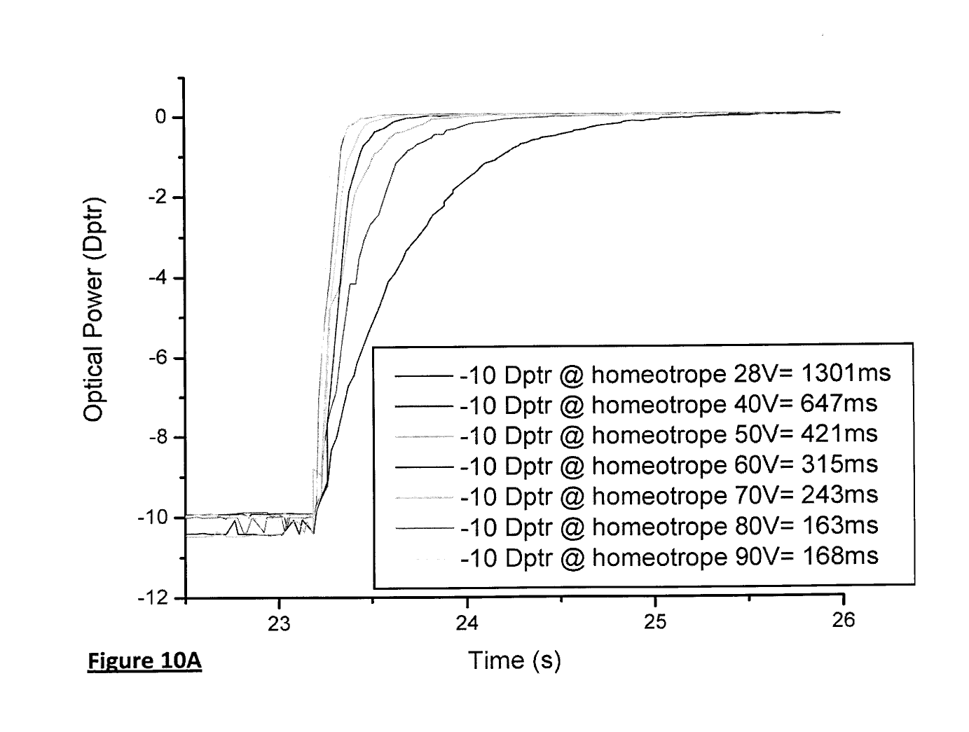

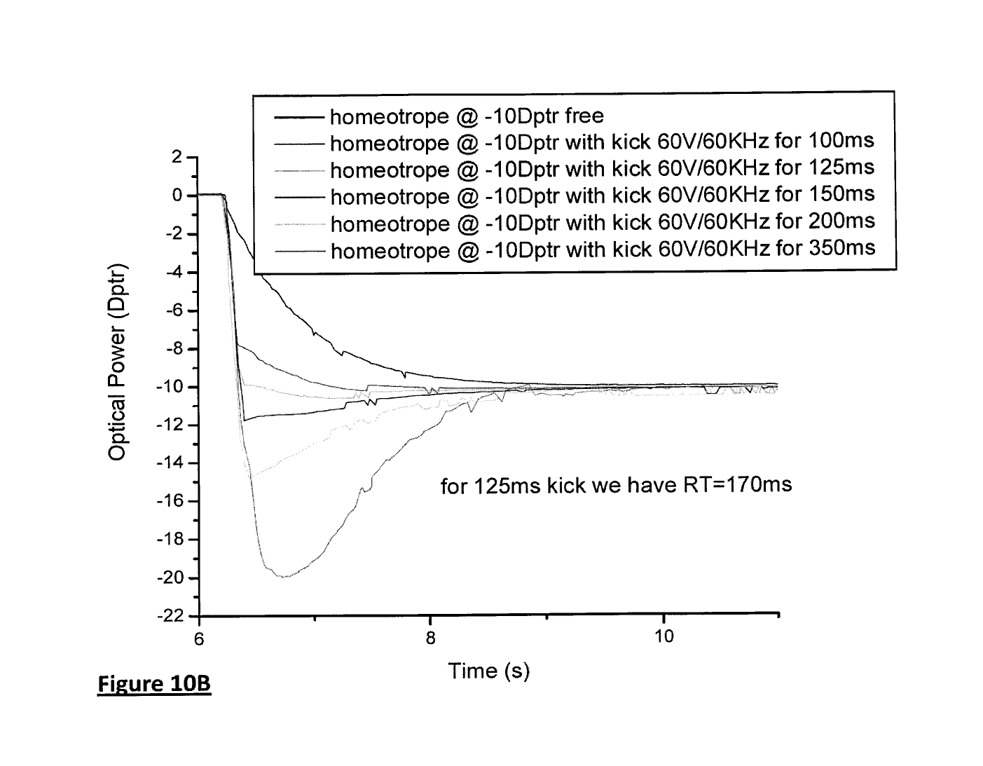

In accordance with the proposed solution, FIGS. 10A and 10B illustrate experimentally measured dynamic transitions in tunable dual frequency liquid crystal lens optical power with drive signal root means square voltage amplitude at constant frequency. While the experimental results are provided for a negative TLC lens, the invention is not limited thereto, with an appropriate changes in TLCL geometry the results apply equally well to a positive lens.

In particular FIG. 10A illustrates a 10 diopter dynamic transition towards 0 (zero) optical power to achieve homeotropic alignment at room temperature. Table 1 summarizes experimental results showing measured times to achieve homeotropic alignment across 10 diopters by applying a drive signal component having f+=2 kHz of various Vrms amplitudes. A shortest homeotropic alignment time of 163 ms is achieved by employing Vrms amplitude of 80V. At f+=2 kHz, the frequency dependent layer 526 allows significant charge mobility which combined with a 80 Vrms amplitude effectively excites the DF-LC TLCL with a substantially uniform electric field to change optical power, in this case to reduce the optical power (reduce absolute optical power).

FIG. 10B illustrates a 10 diopter dynamic transition to increase a lensing effect. Table 2 summarizes experimental results showing measured times to achieve a 10 diopter change by applying a pulsed drive signal component having f−=60 kHz and 60 Vrms amplitude. The low frequency f+ drive signal component is temporarily removed, while applying a high frequency f− pulse of various durations (widths) before reestablishing both low f+ and high f− frequency drive signal components at appropriate steady state Vrms amplitudes of the end state. The shortest optical power change is achieved in 171 ms. At f−=60 kHz, the frequency dependent layer 526 has a low charge mobility however the 60 Vrms amplitude dominates which effectively excites the DF-LC TLCL with a substantially uniform electric field to change optical power, in this case to increase the optical power (increase absolute optical power).

The following experimental results illustrate an optical power change speed improvement from 1301+1820=3121 ms without employing the proposed solution, to 163+171=334 ms by employing the proposed solution.

TABLE 1

| Time to | |
|---|---|
| Homeotropic | f+ = 2 kHz |
| Alignment | Vrms |
| (ms) | (V) |
| 1301 | 28 |
| 647 | 48 |
| 421 | 50 |
| 315 | 60 |
| 243 | 70 |
| 163 | 80 |
| 168 | 90 |

TABLE 2

| Time to | f− = 60 kHz |
|---|---|
| Optical Power | Vrms 60 V |
| Setting | Pulse Duration |
| (ms) | (ms) |
| 1820 | 0 |
| 713 | 100 |
| 171 | 125 |
| 1496 | 150 |
| 2116 | 200 |
| 2522 | 350 |

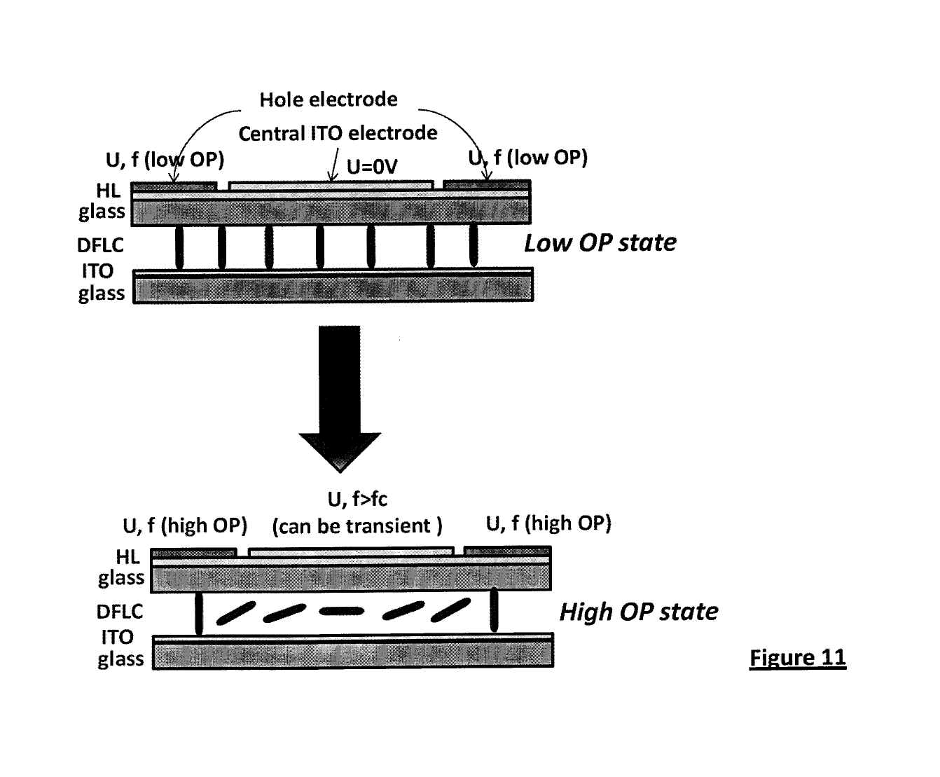

FIG. 11 illustrates another embodiment of the proposed solution, wherein a dual frequency liquid crystal is employed in a TLCL having a structure inspired by Sato with a flat transparent center electrode. A weakly conductive layer having frequency dependent material is also present. The LC cell is filled with MLC-2048 dual frequency liquid crystal material. The operation of the TLCL device of this second embodiment mimics the operation of the first embodiment TLCL, the center electrode is only driven in a transient fashion (during optical power transitions), for example in pulsed fashion.

### Tunable Optical Device System

In accordance with the proposed solution, the frequency variable optical power response of an optical device is employed in a TLC lens to create a lens with a variable focus. Focus can be varied between a minimum and a maximum by employing a mixed frequency and amplitude control based auto-focusing algorithm to provide an improved auto-focusing performance.

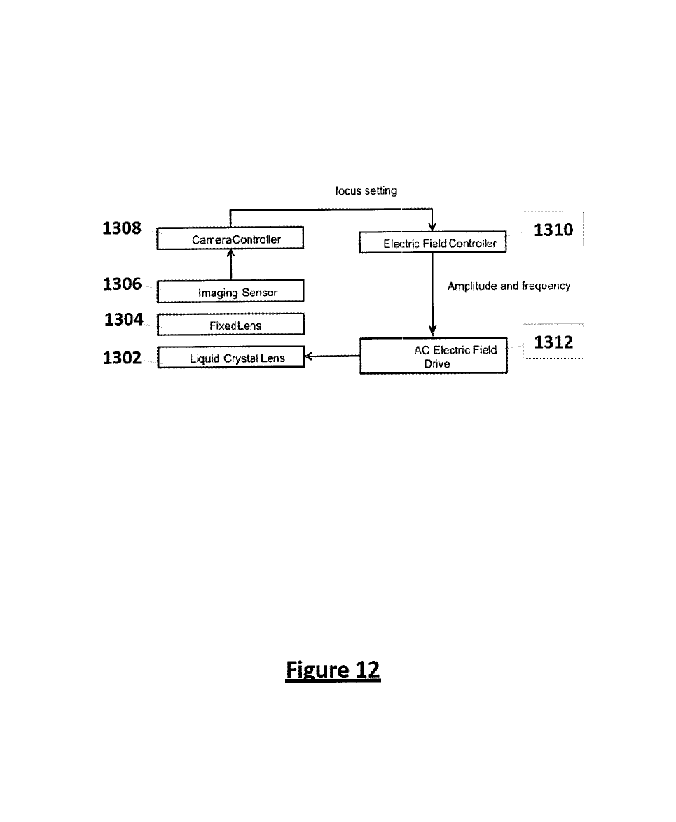

The control signal for tuning the TLCL optical device can be provided by a variable frequency control signal circuit configured to cause said device to control light propagation in the optical device as a function of drive signal frequency. As an example, in FIG. 12, there is shown schematically a digital camera system is schematically illustrated to have a TLC lens 1302 optionally combined with at least one fixed lens 1304 to focus an image onto an image sensor 1306 with the TLC lens 1302 providing focus control. The image is fed to a camera controller 1308 including an auto-focus function that outputs a desired focus value. An electric field controller 1310 translates the focus value into at least one electrical drive signal parameter. Without limiting the invention, the electric field controller 1310 may employ lookup tables in performing its overall function, or at least as such translation function relates to taking into consideration empirical information regarding the TLC lens 1302 and the general optical system, for example: geometry, material characteristics, temperature, camera properties, etc.

An electric field drive circuit 1312 converts the electrical parameters into at least one drive signal to be applied to the TLCL 300/400/500. Those skilled in the art would appreciate that components 1308 and 1310, without limiting the invention, can be implemented using microcode executed on a microcontroller, while component 1312 can include voltage sources switched under the control of a microcontroller to provide a resulting drive signal of desired frequencies and RMS voltages. Such a microcontroller can be configured to obtain focus scores from the image sensor and determine drive signal parameters to operate the TLCL to change optical power towards best focus. For example, best focus can be signaled by detecting minimal focus score change below a threshold.

It will be appreciated that the tunable LC lens optical device 300/400/500 can be fabricated using layer-by-layer assembly and, preferentially, in a parallel way (many units simultaneously, called “wafer level”), the final product being obtained by singulation and, optionally, joining lenses with operation axes (directors) in cross (orthogonal) directions to focus both orthogonal polarizations of light.

### Image Stabilization

Co-pending and commonly assigned International Patent Application Serial No. PCT/CA2010/002023 entitled “Image Stabilization and Shifting in a Liquid Crystal Lens” claiming priority from U.S. 61/289,995 filed Dec. 23, 2009, both of which are incorporated herein by reference, describes variable liquid crystal devices for controlling the propagation of light through a liquid crystal layer using a frequency dependent material to dynamically reconfigure effective electrode structures in the device. In a specific, non-limiting example, shifting or changing the optical axis in a lens forming part of a lens arrangement for a camera is useful for image stabilization, for example: to compensate for camera vibration, image or lens position adjustment to provide alignment with other lens elements, angularly adjusting a lens (pitch and turn/pan and tilt), and provide image movement to achieve sub-pixel imaging using a discreet pixel imaging sensor. Thus, the optical axis adjustment mechanism can be set once, adjusted prior to image acquisition or dynamically adjusted during image acquisition, as required for the given application. In the case of dynamic control, adjustment of the optical axis can be achieved using an accelerometer sensor or by analyzing acquired images to determine camera movement.

In accordance with a variant embodiment of the proposed solution, the use in a TLCL of a Dual Frequency nematic Liquid Crystal (DF-LC) subjected to a spatially modulated electric field generated by a drive signal having at least two amplitude modulated drive signal components with frequencies, one at positive delta epsilon and the other at negative delta epsilon, provides a TLCL continuously operable under excitation conditions while changing an image stabilization state.

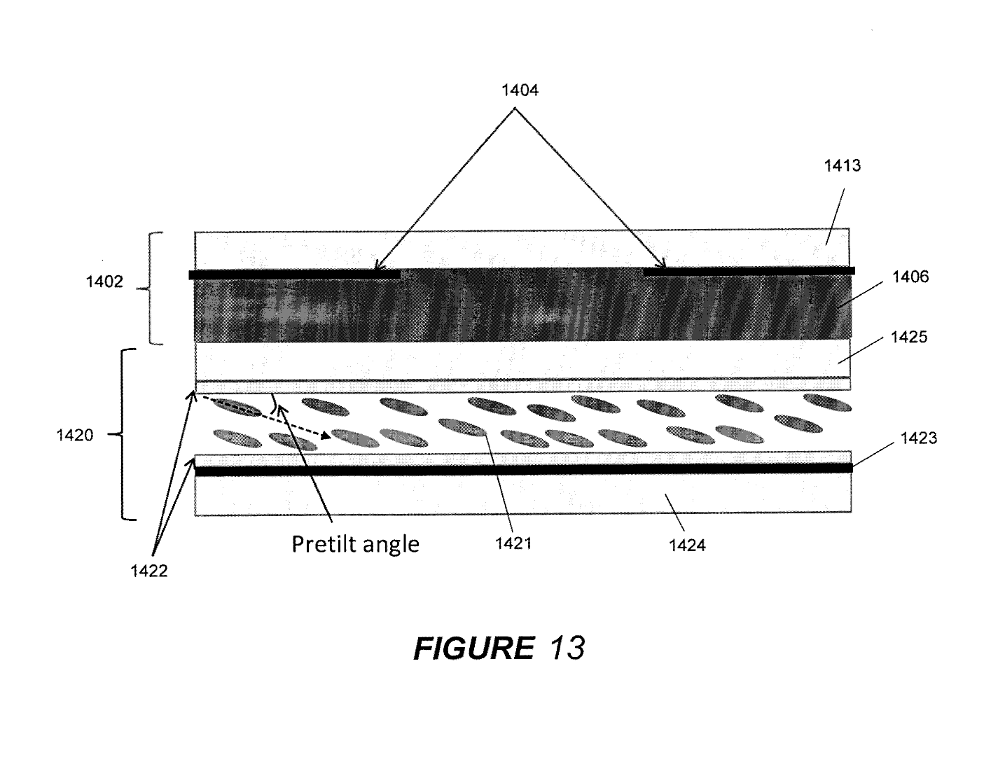

FIG. 13 schematically illustrates a tunable LC lens using a layer 1406 of a frequency dependent material. As discussed above, for a given frequency dependent material, an electrical signal of relatively low frequency can result in a high degree of charge movement (penetration/transport distance) in the material, while a relatively high frequency results in a relatively low degree of charge mobility. When using the frequency dependent material in conjunction with an electrode structure (pair) that generates an electric field in response to an applied drive signal, the extent of charge mobility determines the depth of charge penetration into the frequency dependent material and, therefore, in the context of electric field formation determines the portion of the material that behaves like a “good” conductive layer, as well the portion that behaves like a “poor” conductor. Thus, with a high degree of charge mobility, a larger portion (segment) of the frequency dependent material will appear as a conductor and therefore (appear) act as an extension of a nearby electrode. This frequency dependent characteristic is therefore used in the proposed solution to create dynamically configurable effective electrode surfaces, which can be changed by changing the frequency of the drive signal (or the frequencies of the drive signal components). Changing the effective electrode profile in this manner results in a corresponding change in the profile (spatial modulation) of an electric field between the two electrodes of the electrode structure. With an LC layer located between the electrodes, the dynamically changeable electric field profile can thus be used to dynamically change the optical properties of the LC layer, such as for example the image stabilization state.

Referring again to FIG. 13, the liquid crystal cell 1420 is composed of a layer of LC material 1421, which is sandwiched between “orienting” coatings 1422, formed of a material such as rubbed polyimide. The lower surface of the LCC 1420 includes a relatively uniform transparent conductive layer (i.e., electrode) 1423 formed from a suitable material such as indium tin oxide (ITO). A substrate 1424 (for example glass) is provided (on the lower surface) and supports the transparent conductive layer. Optionally, a middle (buffer) layer 1425 can be provided on the upper surface of the LCC, above uppermost oriented coating 1422.

Specific to the present invention, the LC material 1421 in the liquid crystal cell 1420 is a DF-LC material, such as but not limited to MLC2048 from Merck, exhibiting a dielectric anisotropy. By applying an electrical field generated by at least two fixed frequency drive signal components, one on each side of the crossover frequency along the dielectric anisotropy curve, excitation drive is provided for both reorientation directions. The DFLC molecules can be driven rapidly in both reorientation directions—turned on by a drive signal having a frequency below f_c at which Δ∈>0 and turned off by a drive signal having a frequency above f_c at which Δ∈<0, providing acceleration of image stabilization state transitioning.

In accordance with the variant embodiment, a gradient control structure 1402 of the tunable LC lens uses a hidden electrode to provide spatial modulation of the electric field via frequency tuning. The gradient control structure 1402 is composed of a hole-patterned fixed conductive electrode ring 1404 that, optionally, can be made optically transparent. In FIG. 13, the electrode 1404 is located at the top of the layer of frequency dependent material 1406; alternatively, the electrode 1404 may be located at the bottom of the frequency dependent material 1406. This layer 1406 is the portion of the electrode structure that may also be referred to herein as a hidden electrode. An optional cover substrate 1413 (for example glass) can also be provided in the upper portion of the gradient control structure 1402, above the transparent central electrode 1404 and the frequency dependent layer 1406.

As mentioned above, the frequency dependent layer 1406 includes a complex dielectric material for which the depth of penetration of electrical charge resulting from an applied AC excitation drive signal will be different at different frequencies. The different depths of charge penetration for different frequencies (allows for) provides reconfiguration of the electrode structure by extending (moving) the effective electrode surfaces. In other words, a depth of penetration of electrical charge for one frequency can create an effective, or “virtual,” electrode surface having a different extent (that is in a different position for the effective electrode surface) for a different frequency. As the electrodes are used to generate an electric field that is applied to the LC layer, the different effective electrode surfaces can be used to change the electric field experienced by the LC layer, and therefore to change its optical properties. Thus, for example, a tunable LC lens can be made frequency tunable, since optical properties of the LC cell are controllable by the frequency applied to the electrodes.

Referring again to FIG. 13, the lens shown can operate in different possible regimes. For control drive signal frequencies that have a high degree of charge transport in the frequency dependent layer 1406, the combination of electrode 1404 and layer 1406 will (together) appear as a uniform “top” electrode. That is, the high degree of charge penetration into the layer 1406 will create an “extension” of the electrode 1404, and the effective electrode will extend across the entire extent (length) of the layer 1406, in this configuration across the aperture of the electrode 1404. Since the bottom electrode structure 1423 is also flat and uniform, the electric field across the LC layer will be substantially (approximately) uniform, and the LC molecules will be reoriented uniformly (and without disclinations, which can otherwise affect LC structures that are reoriented by changing the voltage amplitude on a hole patterned electrode). In contrast, if a frequency is applied to the electrodes for which the charge transport through the layer 1406 is very limited, the effective top electrode shape will be close to that of the conductive electrode 1404 alone, and the resulting electric field generated across the LC layer will be non-uniform (spatially modulated). In this example the non-uniform field will be concentrated around the hole patterned electrode 1404, and will change the optical properties of the LC layer 1421 in a predetermined way. Frequency control can thus be used to provide the desired optical tuning.

Frequency control can thus be used to provide the capacity of dynamic control of the effective shape of the electrodes, and thus of the shape of the electric field generated by these electrodes.

Those skilled in the art will recognize that while the frequency dependent layer 1406 is shown in FIG. 13 as being relatively thick as compared to other layers, it can actually be quite thin and used to dynamically create an effective electrode profile based on the location of the frequency dependent material. The “extension” of an electrode can also be in either or both of a direction parallel to, or a direction perpendicular to, an optical axis of the lens.

Within a frequency range between the relatively high and relatively low frequencies discussed above, the frequencies of the drive signal components can be adjusted so as to create a gradually changing optical parameter of the LC layer. An example of this is to create a lens with an effective lens position and shape (i.e. an image stabilization state) that can be controlled or varied by changing the frequency of the driving signal.

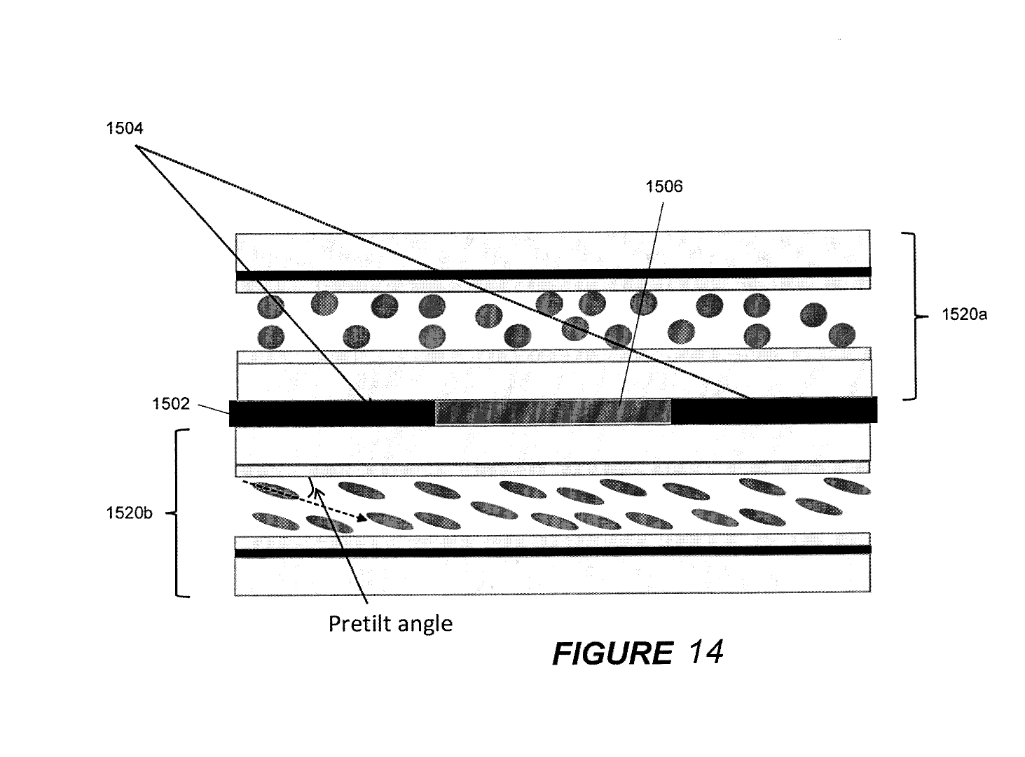

FIG. 14 illustrates an additional variant of a tunable LC lens using a hidden electrode to provide spatial modulation of the electric field via frequency tuning. In FIG. 14, the structure that controls the electric field gradient is composed of a hole patterned peripheral electrode 1504 of fixed (preferably low) electrical resistance, while the central disk-shaped region in the center of this electrode (on the same plane) and the area around that plane is filled by a frequency dependent material 1506. This gradient control structure (GCS) 1502 is sandwiched between two LC cells 1520a, 1520b having directors (average orientation of long molecular axis of LC) in orthogonal planes. For example, one of the directors might be in the XZ plane with the second director being in the YZ plane, the normal of the sandwich being the Z axis. (In this embodiment, one of the traditionally used “internal” electrodes of LC cells is removed to allow the formation of the electric field gradient within the LC layer.) The position of the GCS 1502 can be advantageously used to combine multiple functions for the GCS, such as electrode, heater, and sheet resistance (of frequency dependent material), temperature sensor, optical element shaping, beam steering, pan/tilt, optical error compensation, image stabilization, etc. The heater and the temperature sensor can be used together to help keep the temperature of the device at an optimal level. Additional patterning of the electrode 1504 could also be used to measure the electrical properties of the frequency dependent material 1506, such as sheet resistance, which plays an important role in the formation of the electric field profile, and which might change part-to-part over time with aging. In this context, the GCS can be made in different forms and from a special alloy (e.g., Mo/Al) to perform such multiple functions. Providing a layer that provides spatial modulation of the electric field in the middle of the layered structure (assembly) has the advantage that it equally affects the electric field in the layer or layers below the modulation layer, as well above. By providing a middle electrode in the electrode structure, the separation between electrodes is essentially halved, and in spite of the need to drive two electrode cells simultaneously, the drive signal variations and part-to-part variations are less significant.

Any of the frequency dependent materials discussed herein can be used in the different LC lens configurations above. Such materials have a complex dielectric permittivity that can be varied (including the weakly conductive properties) by the change of driving frequency. The specific characteristics of the material can be selected according to the particular lens structure in question. It should be noted that various material compositions, various LC layers, various electrodes, various geometrical forms, etc. can be used to fabricate the above-described LC lens, without departing from the scope of the claimed invention. It should also be appreciated by the reader that various optical devices can be developed using the LC lens described herein.

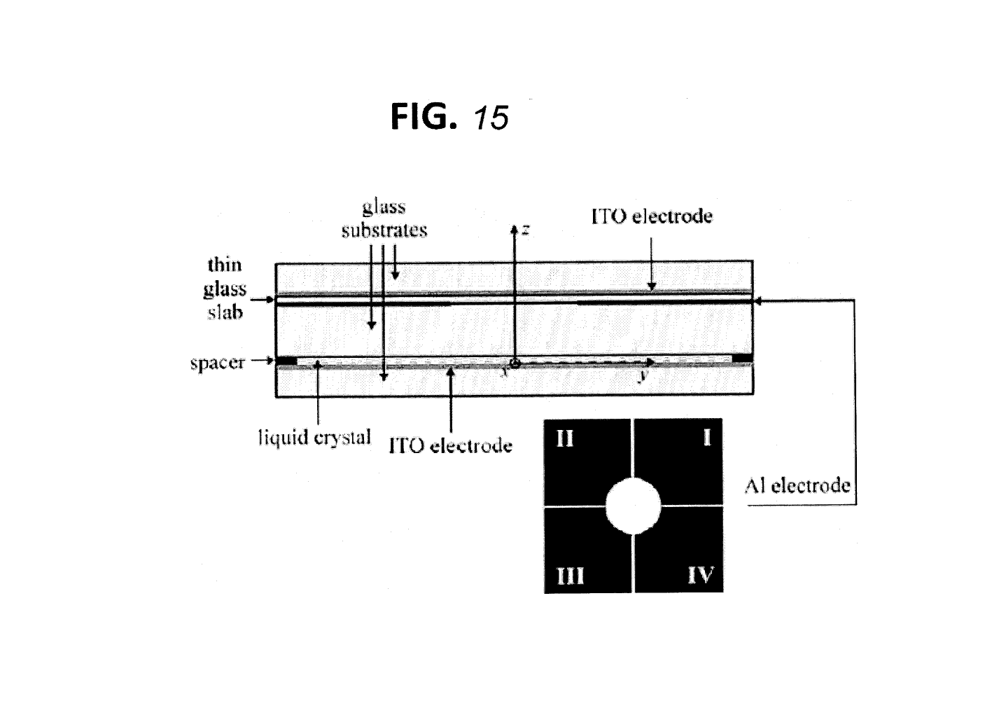

FIG. 15 illustrates a prior art liquid crystal lens design using a uniform planar upper electrode, a segmented four-quadrant electrode placed below the upper electrode, and a bottom uniform planar electrode on a bottom of a liquid crystal cell.

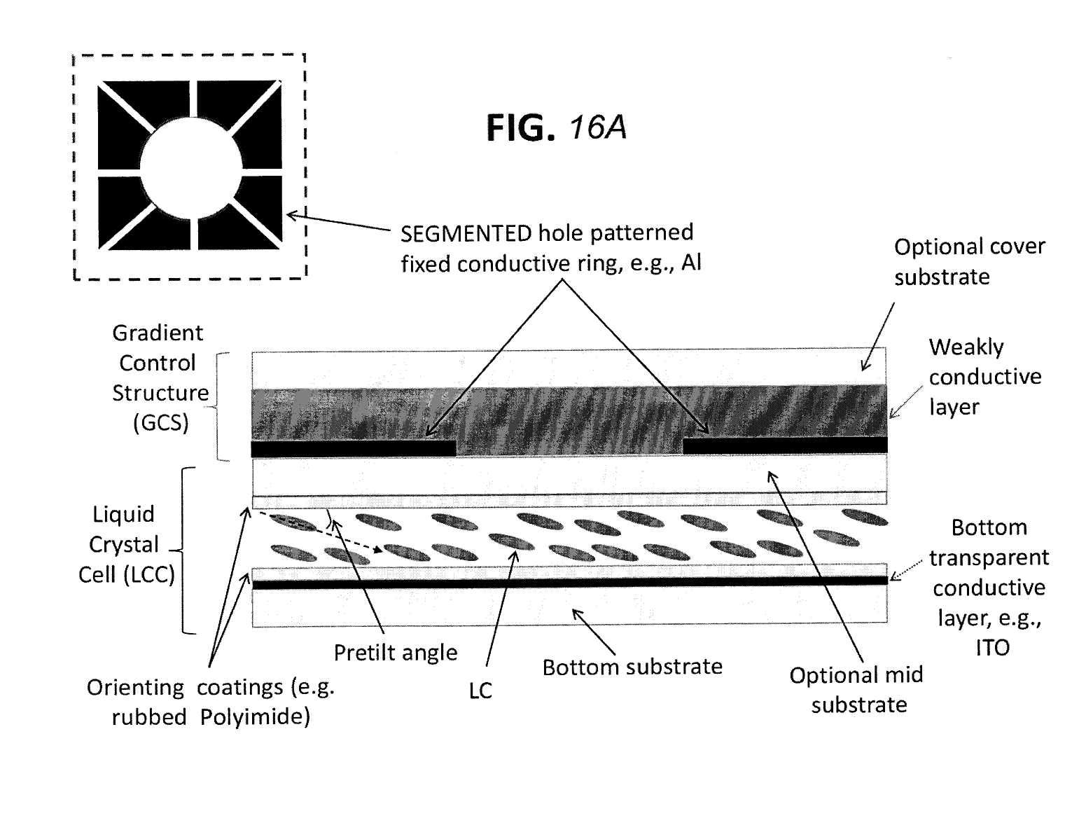

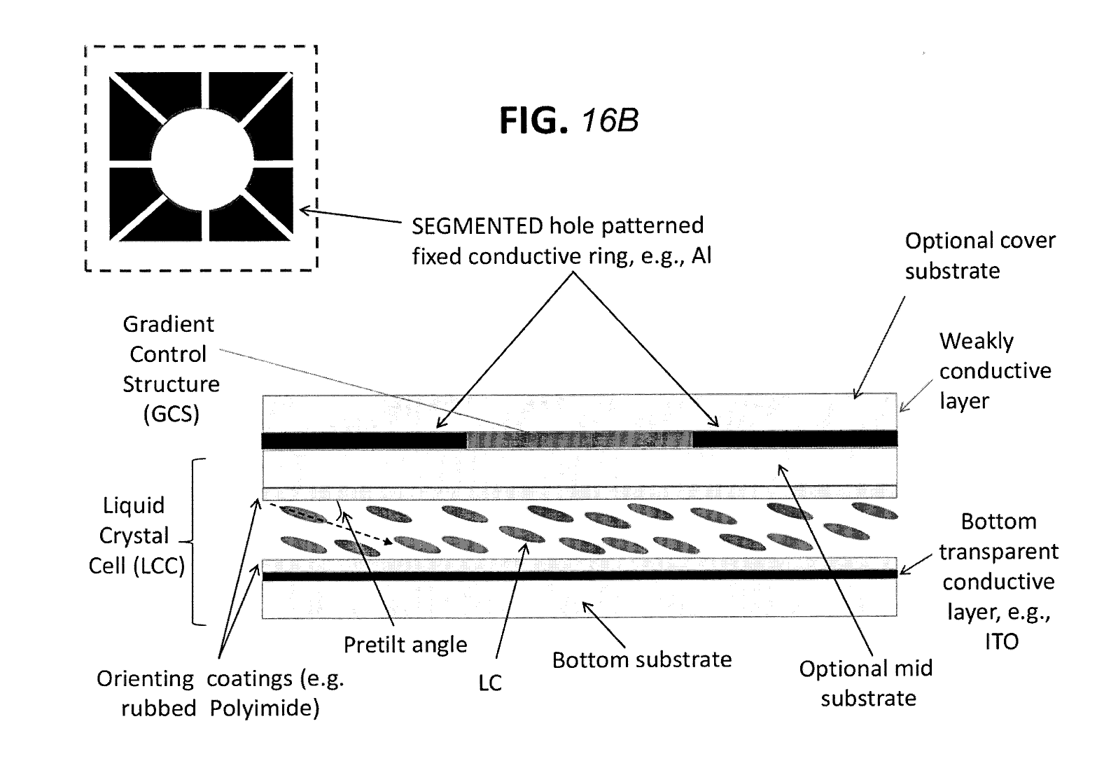

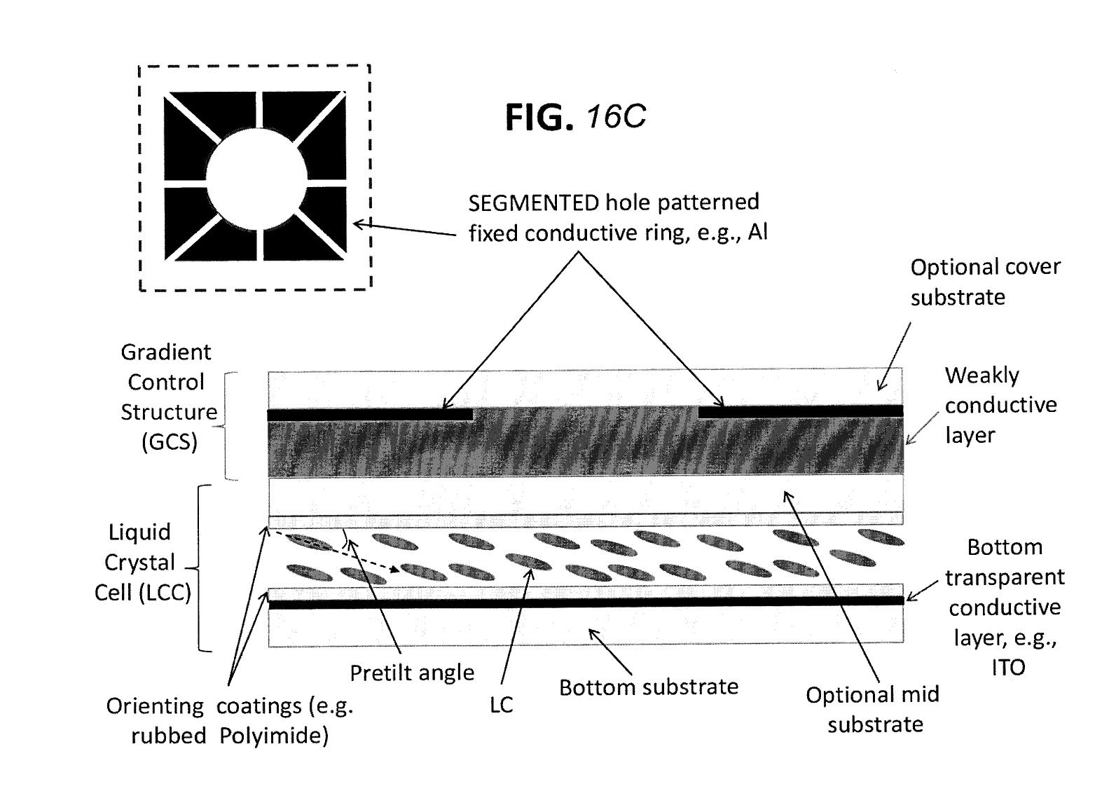

FIG. 16A illustrates a side sectional view of a tunable liquid crystal lens with an inset top view of a segmented top electrode according to an embodiment of the proposed solution in which a frequency dependent material is above the segmented, hole patterned electrode. The positioning of the frequency dependent material can be on top of and covering the segmented electrode, within the aperture of the segmented electrode (see FIG. 16B) or underneath the segmented electrode (see FIG. 16C).

By varying the frequencies of the drive signal components fed to the segments, a complex electric field spatial modulation can be provided. The above described functionality of the weakly conductive layer having frequency dependent material is employed on a per electrode segment basis in order to provide a combined effect to which all electrode segments contribute. That is local charge penetration in the frequency dependent layer is controlled by each electrode segment to control the extent of the patterned electrode in the corresponding immediate vicinity of each electrode segment, the combined extent of all electrode segments being used to spatially modulate the electrical field in a complex way using a symmetric physical structure. The complex spatial modulation of the electric field in turn imparts a particular effect to the incident beam via a complex director orientation in the LC layer exhibiting a complex refractive index distribution across the LC layer.

In the most general sense, the optical element provided by the LC layer is caused to “change shape” in the sense of providing a particular programmed refractive index distribution. The TLC lens can be calibrated with a desired control drive signal of a frequency and an amplitude for each segment as a function of a desired optical effect. A variety of effects can be applied to an incident beam, including both steady state and quasistatic optical effects.

Without limiting the invention, for video/image acquisition applications specific sets of frequency and amplitude drive signal components are useful and a controller can draw on calibrated values from a calibration look-up-table. For example, optical power adjustment and optical axis reorientation are used in video/image acquisition to provide focusing functionality and to stabilize the image to be acquired by moving the optical axis of the TLC lens to compensate for camera motion (handheld/vibration environment). For image tracking applications, optical axis reorientation is employed to keep stable a moving scene.

It is important to reemphasize that a TLC lens having a frequency dependent weakly conductive layer implementing functionality described herein above can be employed in providing image stabilization, for example by employing a suitable feedback mechanism such as but not limited to an accelerometer. Image stabilization is important in handheld applications as well in vibrating environments. A prior art attempt by Bryan James, Andrew Hodge and Aram Lindahl described in US 20100309334 filed in Jun. 5, 2009 proposes continuous acquisition of multiple images into a very large buffer without image stabilization and the selection of an image from the acquired set in post processing based on an image acquisition time at which a motion sensor registered least motion. In contrast, employing an active feedback mechanism and active image stabilization in accordance with the proposed solution herein is enabled by a fast TLCL response and provides a reduction in image storage and vast fast memory requirements.

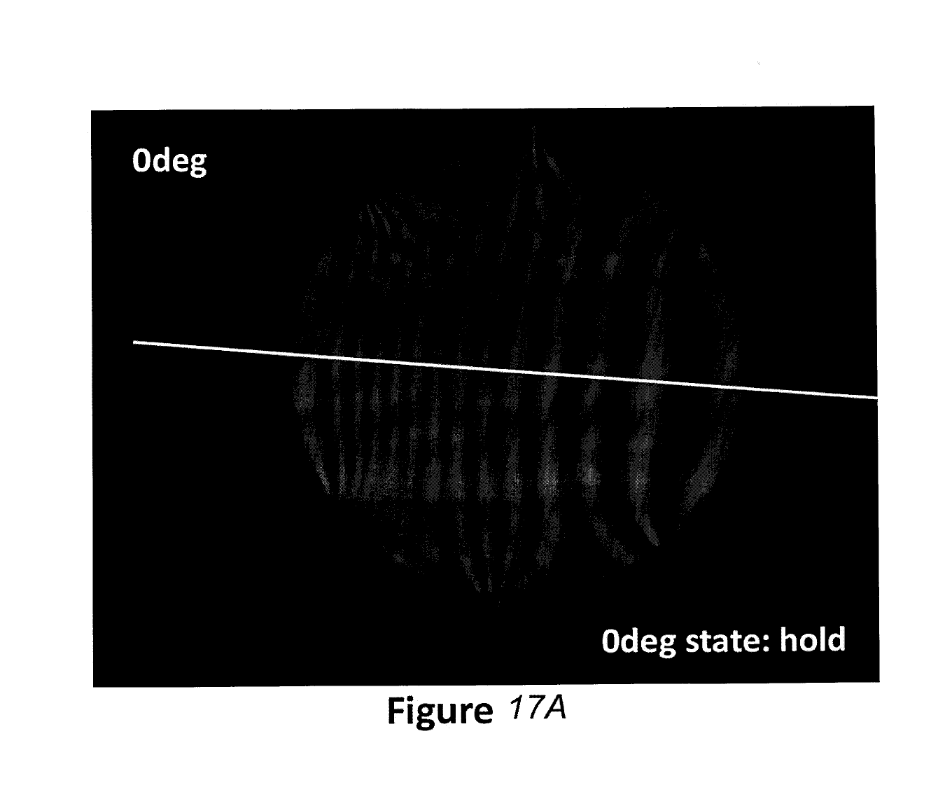

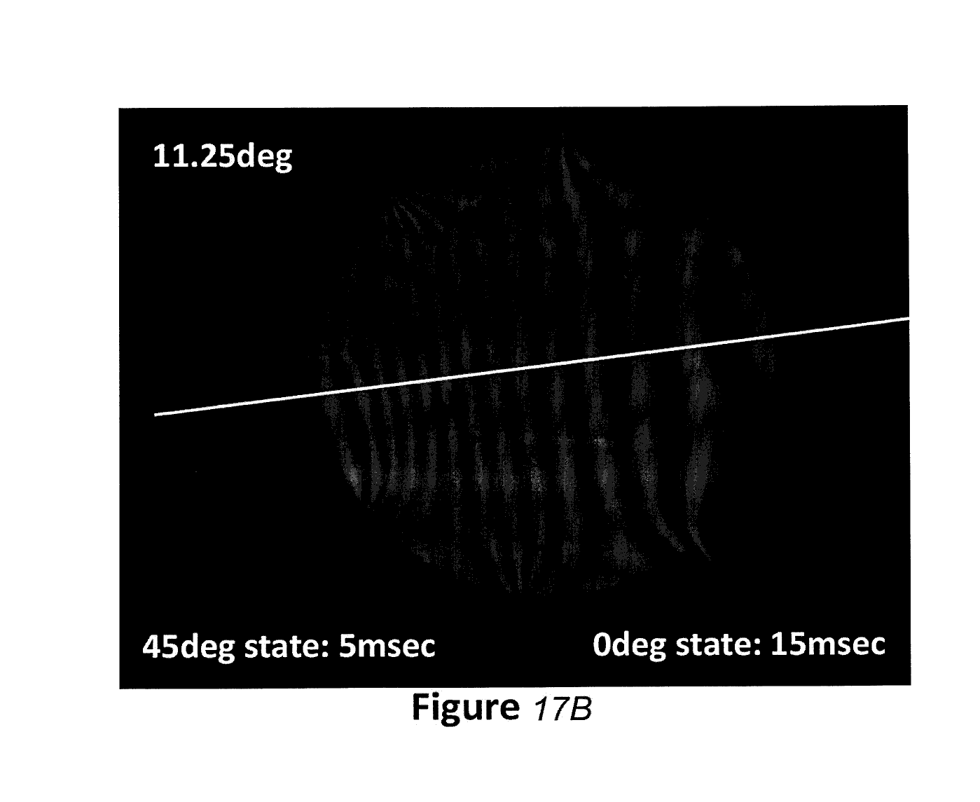

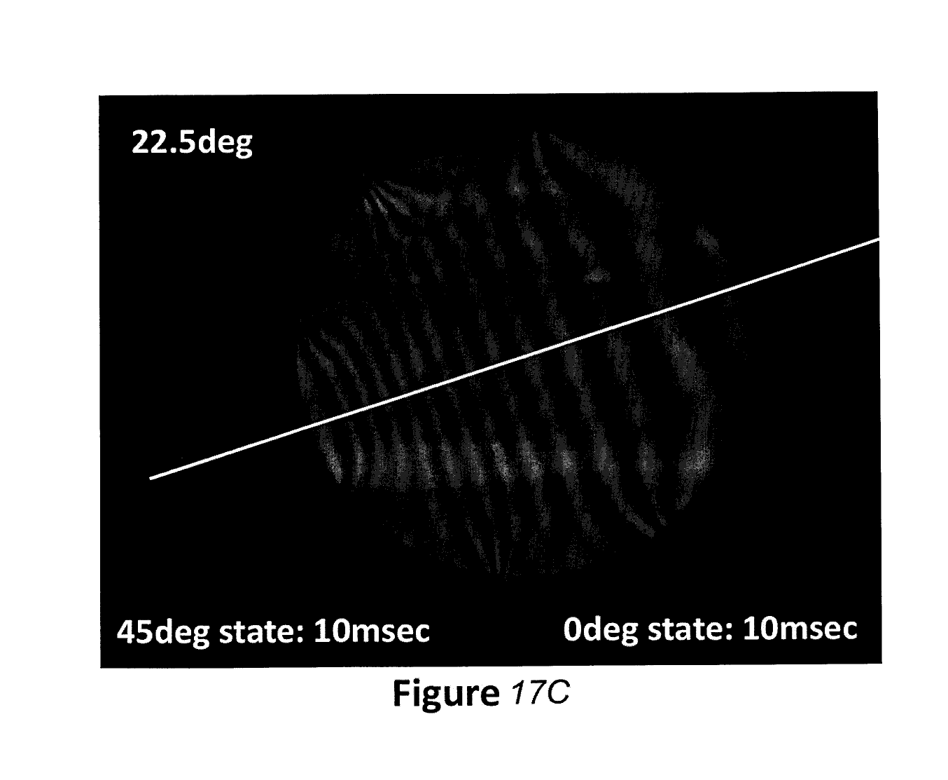

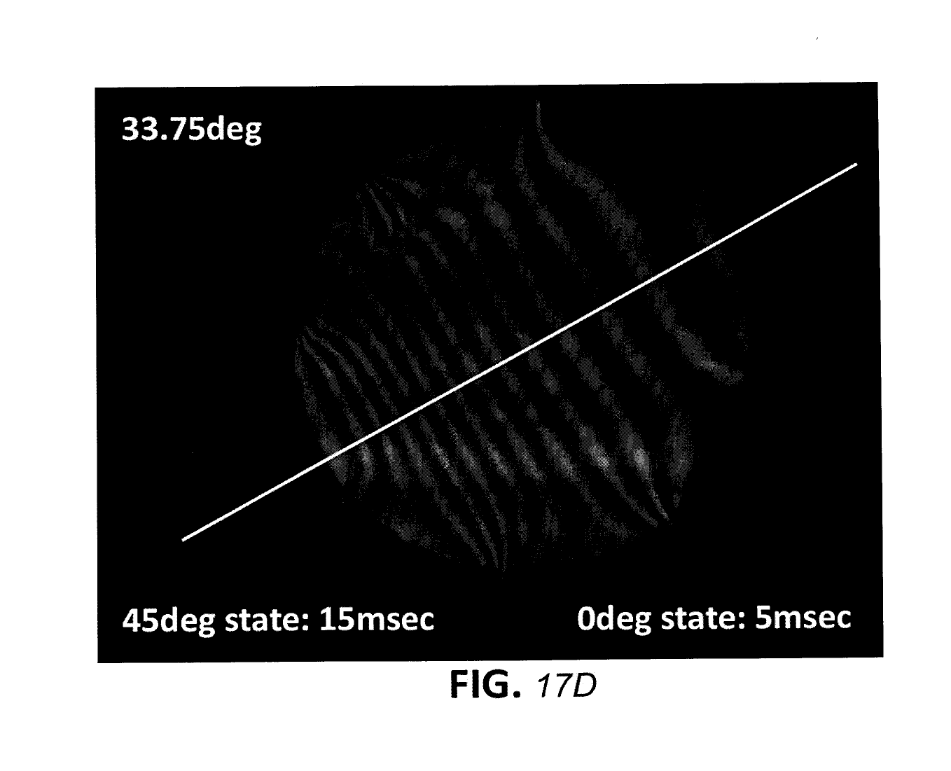

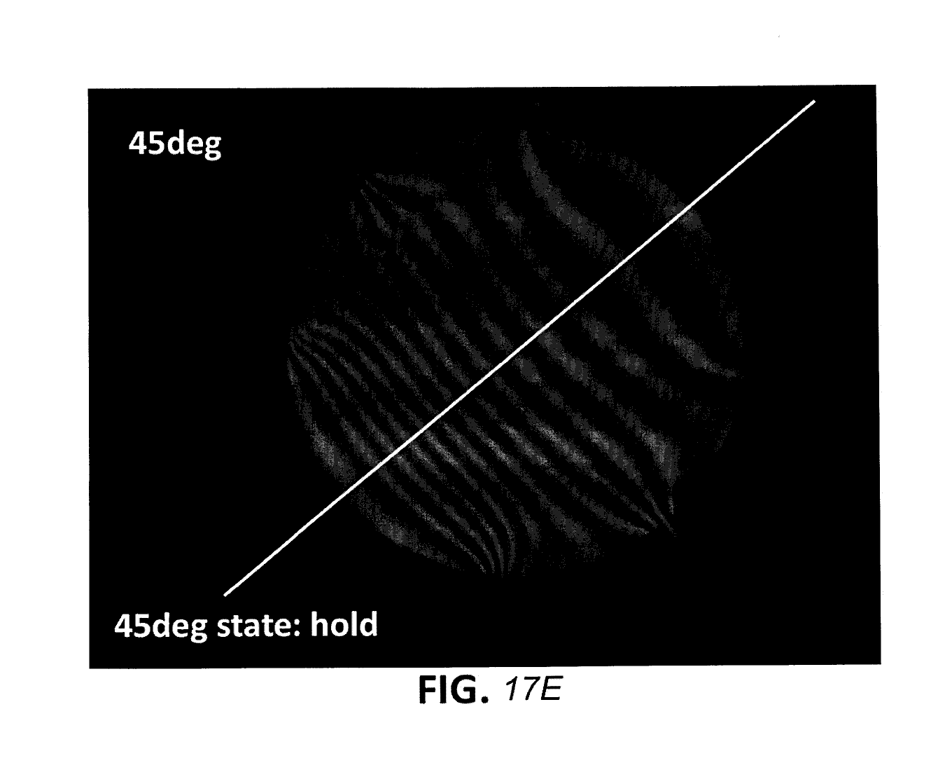

Multiple time variant (phase shifted) drive signal components may be employed to provide further optical property control. For example FIGS. 17A to 17E illustrate quasistatic control of an eight segment hole patterned electrode (using four drive signal components) wherein an arbitrary direction of optical axis tilt is provided between 0 deg and 45 deg.

While the proposed solution has been described with reference to using a drive signal having dual frequency, the invention is not limited to the use of dual frequency. A multitude of frequencies may be mixed together and applied simultaneously to create a desired profile for the electric field (via the frequency dependent material). In one implementation, the multitude of frequencies combine to produce a pulse width modulated signal for which the filling factor may be varied. The filling factor may be modified to change the amount of high frequency content in the signal.

While the proposed solution has been described with reference to using a single weakly conductive layer having a frequency dependent material, the invention is not limited to the use of a single frequency dependent material. A number of different frequency dependent materials, not necessarily positioned at a single location relative to the conductive electrodes 124 and 322/522, may be employed in order to shape the electrical field of the optical device. As well a frequency dependent layer having a frequency dependent charge mobility that varies along a gradient therethrough may be employed.

The frequency dependent materials may consist of a variety of different possible materials. In one embodiment, the frequency dependent material is a thermally polymerizable conductive material, while in another embodiment frequency dependent material is a photo polymerizable conductive material. Other possibilities include vacuum (or otherwise, e.g. “sol-gel”) deposited thin films, high dielectric constant liquids, electrolyte gels, conductive ionic liquids, electronic conductive polymers, materials with electronic conductive nanoparticles, etc. The desired feature of the frequency dependent material being that it has a charge mobility that is frequency dependent. When the frequency dependent material is a thermally or photo polymerizable conductive material, it may include: a polymerizable monomer compound having at least one ethylenically unsaturated double bond; an initiator that is a combination of UV-vis, NIR sensitive or thermally sensitive molecules; an additive to change the dielectric constant of the mixture, where the additive is selected from the group consisting of organic ionic compounds and inorganic ionic compounds; and a filler to change a viscosity of the mixture. The material may also include an adhesive selective from the group consisting of adhesives sensitive to UV-Vis, adhesives sensitive to NIR and adhesives polymerized using a thermal initiator. An optical elastomer may also be included.

When the frequency dependent material is a high dielectric constant liquid, it may include a transparent liquid material having an epsilon between 2.0 and 180.0 at a relatively low frequency that allows electric charge to move in a frequency dependent manner. When the frequency dependent material is an electrolyte gel material, it may include: a polymer material; an ionic composition; and an ion transporter. When the frequency dependent material is a conductive ionic liquid, it may include an ionic species selected from the group consisting of chlorate, perchlorate, borate, phosphate and carbonate.

While the proposed solution has been described with reference to a TLC lens, without limiting the invention, the proposed solution can be applied to a multitude of optical devices including, for example: a beam steering device, an optical shutter, etc.

It will be appreciated that one TLCL can provide variable focus optical element, while two TLCLs can provide a zoom lens.

Those skilled in the art will recognize that the various principles and embodiments described herein may also be mixed and matched to create a TLC lens optical devices with various auto-focus characteristics. Electrodes of different shapes and configurations; frequency dependent materials of different types, shapes and positions; dual frequency liquid crystal materials of different types; different drive signal generators; etc. can be used in combination to create a TLC lens optical device with a particular characteristic. The TLC lens devices may be frequency controlled, voltage controlled, or controlled by a combination of the two.

1. A tunable optical device comprising:
a layered structure including:
a liquid crystal layer including a dual frequency liquid crystal material, said dual frequency liquid crystal material exhibiting a dielectric anisotropy about a crossover frequency at a corresponding temperature;
a pair of liquid crystal orienting layers sandwiching said liquid crystal layer therebetween to form a liquid crystal cell, each of said orienting layers including a coating rubbed in a predetermined direction to induce liquid crystal molecular alignment at a low pretilt angle in a ground state; and
an electrode structure, said electrode structure and said electrode layer sandwiching said liquid crystal cell; and
a control drive signal circuit coupled to substantially simultaneously provide a first drive signal component of a frequency lower than said crossover frequency and a second drive signal component of a frequency higher than said crossover frequency to said electrode structure.

2. A tunable optical device as claimed in claim 1, wherein when said drive signal components are provided a combined spatially modulated electric field is applied across said liquid crystal cell inducing a spatially modulated director orientation in the liquid crystal cell, said spatially modulated director orientation causing a spatially modulated optical property variation in a light beam passing through said liquid crystal cell.

3. A tunable optical device as claimed in claim 1, wherein said layered structure further comprises a transparent weakly conductive layer filling at least an aperture in said electrode structure, said weakly conductive layer including frequency dependent material allowing frequency dependent charge mobility within said weakly conductive layer.

4. A tunable optical device as claimed in claim 3, wherein when said drive signal components are provided, said frequency dependent charge mobility causes said electrode structure to have a drive signal frequency specific effective electric profile, said first drive signal component applying an electric field component having a substantially flat spatial distribution, said second drive signal component applying a spatially variant electric field component.

5. A tunable optical device as claimed in claim 3, said weakly conductive layer being further configured to soften a gradient of said spatially modulated electric field.

6. A tunable optical device as claimed in claim 3, said frequency dependent material further causing said weakly conductive layer to function as a frequency-responsive electric field gradient control layer configured to shape said spatially modulated electric field.

7. A tunable optical device as claimed in claim 1, comprising one of a lens, a beam steering device, and an optical shutter, wherein controlled variation in liquid crystal molecular orientation via said combined spatially modulated electric field respectively causes said liquid crystal layer to respectively focus, steer and block said light beam.

8. A tunable optical device as claimed in claim 1, said electrode structure comprising a hole patterned electrode imparting an angularly symmetric electric field spatial modulation, said optical device being a tunable liquid crystal lens and said optical property being optical power.

9. A tunable optical device as claimed in claim 8, said hole patterned electrode being configured to define an optical aperture of said tunable liquid crystal lens.

10. A tunable optical device as claimed in claim 1, said electrode structure comprising a segmented ring electrode, said control drive signal circuit applying a separate one of said first and second drive signal components to each electrode segment, said optical property being optical image stabilization.

11. A tunable optical device as claimed in claim 10, wherein said optical device is a tunable liquid crystal lens, driving said segmented ring electrode providing a parametric lens.

12. A tunable optical device as claimed in claim 1, wherein said liquid crystal material comprises dual frequency liquid crystal material MLC-2048.

13. A tunable optical device as claimed in claim 1, comprising a buffer substrate between said electrode structure and said liquid crystal cell, said buffer substrate being configured to provide a reduction in a sensitivity to liquid crystal cell thickness.

14. A tunable optical device as claimed in claim 1, said electrode structure further comprising a second transparent electrode layer opposite said first transparent electrode layer across said liquid crystal cell, said second transparent electrode layer being driven by a transient drive signal component in changing optical power.

15. A tunable optical device as claimed in claim 2, said tunable optical device causing said spatially modulated optical property variation in respect of a single light polarization of said light beam, said tunable optical device further comprising a dual structure configured to cause complimentary optical property variations for two orthogonal light polarizations.

16. A tunable optical device as claimed in claim 15, said dual structure having orthogonal liquid crystal orienting layer rubbing directions between liquid crystal cells, each said polarization being linear, said dual structure being configured to provide full polarization optical property variation.

17. A camera lens assembly employing the tunable optical device of claim 1.

18. A camera module employing the tunable optical device of claim 1, the camera module further comprising an image sensor and at least one image acquisition component.

19. A camera module as claimed in claim 18, said at least one image acquisition component further comprising an electric field controller for focusing said tunable liquid crystal lens.

20. A method of operating a tunable liquid crystal optical device having a liquid crystal layer and an electrode structure, said liquid crystal layer including a dual frequency liquid crystal material exhibiting a dielectric anisotropy about a crossover frequency, said electrode structure arranged to act on said liquid crystal layer, said method comprising substantially simultaneously applying to said electrode structure a first drive signal component having a frequency below said crossover frequency at a first amplitude and a second drive signal component having a frequency above said crossover frequency at a second amplitude, such that liquid crystal molecular directors in said liquid crystal layer are excited by a differential of said first and second drive signal components to cause said tunable liquid crystal optical device to express a corresponding optical property value.

21. A method as claimed in claim 20, further comprising applying an initial low frequency drive signal component to align said liquid crystal molecular directors at an initial low pretilt excitation angle.

22. A method as claimed in claim 20, wherein said optical property is optical power, changing either one of said first and second drive signal components further causing a change in optical power between low and high optical powers in absolute terms in a corresponding one of a positive and negative direction.

23. A method as claimed in claim 22, wherein changing either one of said first and second drive signal components further causes a change in optical power between negative and positive optical powers.

24. A method as claimed in claim 22, further comprising:
extinguishing said first drive signal component and applying said second drive signal component for a predetermined duration at a predetermined amplitude to cause an optical power change; and
reestablishing both said drive signal components after said predetermined duration at frequencies and amplitudes corresponding to a desired end optical power value.

25. A method as claimed in claim 20, wherein said optical device is a tunable liquid crystal lens and said optical property is optical image stabilization, changing either one of said first and second drive signal components further causing a change in effective lens position and/or shape.

26. An auto-focus method for acquiring focus in an imaging system using a tunable liquid crystal lens, the tunable liquid crystal lens having a liquid crystal layer and an electrode structure, the liquid crystal layer including a dual frequency liquid crystal material exhibiting a dielectric anisotropy about a crossover frequency, the electrode structure arranged to act on the liquid crystal layer, liquid crystal molecular directors in the liquid crystal layer being excited by a differential of first and second drive signal components simultaneously applied to the electrode structure to cause the tunable liquid crystal lens to express a corresponding optical power value, the first drive signal component having a frequency below the crossover frequency at a first amplitude and the second drive signal component having a frequency above the crossover frequency at a second amplitude, said method comprising:
changing either one of said first and second drive signal components to cause a change in optical power between low and high optical powers in absolute terms in a corresponding one of a positive and negative direction;
obtaining a focus score;
determining parameters for said drive signal components to cause the focus score to change; and
repeating said method.

27. An auto-focus method as claimed in claim 26, wherein said determining parameters further comprises determining parameters for said drive signal components to cause the focus score to increase following obtaining at least two focus scores.

28. An auto-focus method as claimed in claim 26, wherein said determining parameters further comprises detecting a subsequent obtained focus score being within a threshold of a previous focus score and signaling focus acquisition.

29. An auto-focus method as claimed in claim 26, wherein said determining parameters further comprises determining at least one drive signal component amplitude parameter.

30. An auto-focus method as claimed in claim 26, wherein said lens is a tunable optical device as claimed in claim 1.
